(19) United States
(12) Patent Application Publication
(10) Pub. No.: US 2026/0143530 A1
(43) Pub. Date: May 21, 2026

(54) RANDOM ACCESS OCCASION MAPPING IN ASSOCIATION PERIODS

(71) Applicant: QUALCOMM Incorporated, San Diego, CA (US)

(72) Inventors: Ahmed Attia ABOTABL, San Diego, CA (US); Jae Ho RYU, San Diego, CA (US); Ambarish TRIPATHI, San Diego, CA (US); Hung Dinh LY, San Diego, CA (US)

(21) Appl. No.: 18/949,893

(22) Filed: Nov. 15, 2024

(51) Int. Cl. H04W 74/0833; H04L 5/00

(52) U.S. Cl. CPC H04W 74/0833; H04L 5/0048

(57) ABSTRACT

Certain aspects of the present disclosure provide techniques for wireless communications. An example method includes obtaining a configuration that indicates a plurality of additional random access occasions (ROs), wherein one or more synchronization signal blocks (SSBs) of a plurality of SSBs are mapped to a set of additional ROs of the plurality of additional ROs, the set of additional ROs comprising a first set of additional ROs in a first association period and a second set of additional ROs in a second association period, wherein for each of the first association period and the second association period, the one or more SSBs of the plurality of SSBs are mapped starting at the lowest SSB index value; and performing a random access channel (RACH) procedure using at least one RO of a set of legacy ROs or the set of additional ROs.

### INTRODUCTION

### Field of the Disclosure

Aspects of the present disclosure relate to wireless communications, and more particularly, to techniques for random access communications.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining a first configuration that indicates a plurality of legacy random access occasions (ROs), wherein a plurality of synchronization signal blocks (SSBs) are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value; obtaining a second configuration that indicates a plurality of additional ROs, wherein one or more SSBs of the plurality of SSBs or a second plurality of SSBs are mapped to a set of additional ROs of the plurality of additional ROs, the set of additional ROs comprising a first set of additional ROs in the first association period and a second set of additional ROs in the second association period, wherein for each of the first association period and the second association period, the one or more SSBs of the plurality of SSBs or the second plurality of SSBs are mapped starting at the lowest SSB index value; and performing a random access channel (RACH) procedure using at least one RO of the set of legacy ROs or the set of additional ROs.

Certain aspects provide a method for wireless communications by a UE. The method includes obtaining a first configuration that indicates a plurality of legacy ROs, wherein a plurality of SSBs are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value; obtaining a second configuration that indicates a plurality of additional ROs, wherein the plurality of SSBs or a second plurality of SSBs are mapped to a set of additional ROs of the plurality of additional ROs irrespective of the first association period and the second association period; and performing a RACH procedure using at least one RO of the set of legacy ROs or the set of additional ROs.

Certain aspects provide a method for wireless communications by a UE. The method includes obtaining a first configuration that indicates a plurality of legacy ROs, wherein a plurality of SSBs are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value; obtaining a second configuration that indicates a plurality of additional ROs, wherein one or more SSBs of the plurality of SSBs or a second plurality of SSBs are mapped to a set of additional ROs of the plurality of additional ROs, the set of additional ROs comprising a first set of additional ROs in a third association period and a second set of additional ROs in a fourth association period, wherein for each of the third association period and the fourth association period, the plurality of SSBs or the second plurality of SSBs are mapped starting at the lowest SSB index value; and performing a RACH procedure using at least one RO of the set of legacy ROs or the set of additional ROs.

Certain aspects provide a method for wireless communications by a network entity. The method includes sending, to a UE, a first configuration that indicates a plurality of legacy ROs, wherein a plurality of SSBs are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value; sending, to the UE, a second configuration that indicates a plurality of additional ROs, wherein one or more SSBs of the plurality of SSBs or a second plurality of SSBs are mapped to a set of additional ROs of the plurality of additional ROs, the set of additional ROs comprising a first set of additional ROs in the first association period and a second set of additional ROs in the second association period, wherein for each of the first association period and the second association period, the one or more SSBs of the plurality of SSBs or the second plurality of SSBs are mapped starting at the lowest SSB index value; and performing a RACH procedure with the UE based on at least one RO of the set of legacy ROs or the set of additional ROs.

Certain aspects provide a method for wireless communications by a network entity. The method includes sending, to a UE, a first configuration that indicates a plurality of legacy ROs, wherein a plurality of SSBs are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value; sending, to the UE, a second configuration that indicates a plurality of additional ROs, wherein the plurality of SSBs or a second plurality of SSBs are mapped to a set of additional ROs of the plurality of additional ROs irrespective of the first association period and the second association period; and performing a RACH procedure with the UE based on at least one RO of the set of legacy ROs or the set of additional ROs.

Certain aspects provide a method for wireless communications by a network entity. The method includes sending, to a UE, a first configuration that indicates a plurality of legacy ROs, wherein a plurality of SSBs are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value; sending, to the UE, a second configuration that indicates a plurality of additional ROs, wherein one or more SSBs of the plurality of SSBs or a second plurality of SSBs are mapped to a set of additional ROs of the plurality of additional ROs, the set of additional ROs comprising a first set of additional ROs in a third association period and a second set of additional ROs in a fourth association period, wherein for each of the third association period and the fourth association period, the plurality of SSBs or the second plurality of SSBs are mapped starting at the lowest SSB index value; and performing a RACH procedure with the UE based on at least one RO of the set of legacy ROs or the set of additional ROs.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5A depicts an example four-step random access procedure.

FIG. 5B depicts an example two-step random access procedure.

FIG. 6 depicts an example association period configuration for a synchronization signal block/physical broadcast channel block (SSB)-random access occasion (RO) mapping scheme for legacy ROs.

FIG. 7 depicts an example association period configurations for SSB-RO mapping schemes for legacy ROs and additional ROs.

FIG. 8 depicts an example wireless communications network.

FIGS. 9A and 9B depict example SSB-RO mapping schemes for additional ROs.

FIGS. 10A and 10B depict example SSB-RO mapping schemes for additional ROs.

FIGS. 11A and 11B depict example SSB-RO mapping schemes for additional ROs.

FIG. 12 depicts a process flow for communications in a wireless communications network between a network entity and a UE.

FIG. 13 depicts a method for wireless communications.

FIG. 14 depicts another method for wireless communications.

FIG. 15 depicts another method for wireless communications.

FIG. 16 depicts another method for wireless communications.

FIG. 17 depicts another method for wireless communications.

FIG. 18 depicts another method for wireless communications.

FIG. 19 depicts aspects of an example communications device.

FIG. 20 depicts aspects of an example communications device.

### DETAILED DESCRIPTION

Aspects of the present disclosure provide apparatuses, methods, processing systems, and computer-readable mediums for mapping synchronization signal/physical broadcast channel blocks (SSBs) to random access occasions (ROs) for additional ROs.

In certain wireless communication systems (e.g., 5G New Radio systems and/or any future wireless communications system), a user equipment (UE) may communicate with a network entity (e.g., a base station) using a random access procedure, for example, for initial access to the network entity, for beam failure recovery, to obtain timing information (e.g., a timing advance), to request uplink communication resources, to request system information, etc. An example random access procedure may begin with the UE sending a random access preamble on a physical random access channel (PRACH) in an RO, where the RO may include one or more time-frequency resources configured for the UE to perform a random access channel (RACH) procedure to establish a connection with the network entity. In some aspects, the RO may be referred to as a PRACH occasion. Upon successful reception of the preamble, the network entity sends a response to the preamble in a random access response (RAR) window. The response may include an uplink scheduling grant. On receiving the response, the UE may send a request to set up a connection with the network entity, and then, the network entity may reply with a contention resolution response.

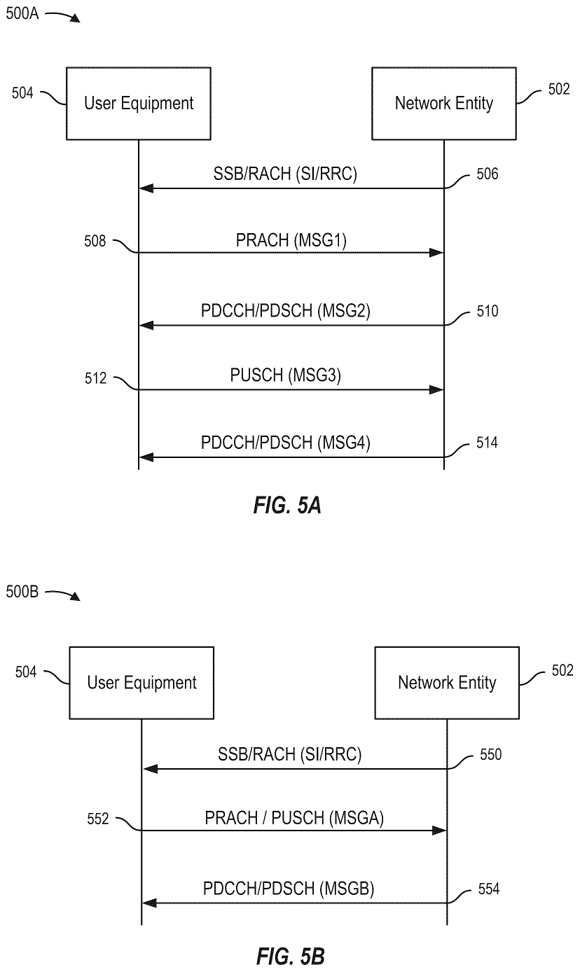

In certain cases, a UE obtains a configuration for random access communications via system information that is broadcast by the network entity. The configuration may identify certain parameters for random access communications, such as a set of preambles, a periodicity for the ROs, and/or a duration for the RAR window. Certain aspects associated with random access communications are further described herein, for example, with respect to FIGS. 5A and 5B.

In some aspects, a UE may obtain multiple configurations for the random access communications. For example, the UE may obtain a first PRACH configuration that is configured for “legacy” UEs, such as UEs that are not configured for a current generation of wireless communications and that have less advanced circuitry and/or processing capabilities than UEs configured for a current generation of wireless communications, but the first PRACH configuration can be used by any UE. Accordingly, the first PRACH configuration may be referred to as a legacy PRACH configuration. In some aspects, the first PRACH configuration may include the above described parameters for random access communications for the legacy UEs (and can be used by any device or UE), such that the ROs indicated in the first PRACH configuration may be referred to as legacy ROs. Additionally, in some aspects, a UE may obtain a second PRACH configuration that is configured for additional UEs, such as UEs that are configured for the current generation of wireless communications and that have the advanced circuitry and/or processing capabilities, such that the second PRACH configuration is not available to be used by the legacy UEs. In some aspects, the second PRACH configuration may include the above described parameters for random access communications for the additional UEs, and the ROs indicated in the second PRACH configuration may be referred to as additional ROs.

The additional ROs may represent an adaptation to PRACH configurations in the time domain, such as increasing a number of ROs (e.g., via the additional ROs) that are available for the additional UEs to use for the random access communications in addition to the legacy ROs. For example, the adaptation may be based on the configuration of the additional ROs (e.g., additional PRACH resources) via the second PRACH configuration for network energy savings (NES)-capable UEs in addition to the configuration of the legacy ROs (e.g., legacy PRACH resources) via the first PRACH configuration for the legacy UEs. That is, the additional UEs (e.g., NES-capable UEs) can use both the additional ROs and the legacy ROs when attempting to perform a RACH procedure to establish a connection with the network entity.

Additionally or alternatively, adaptations to the PRACH configurations may be performed in a spatial domain. In some aspects, the network entity may send SSBs to UEs located in a coverage area of the network entity, where the SSBs are sent via respective beams. The SSBs and corresponding beams may be associated with one or more respective ROs (e.g., the SSBs and/or corresponding beams are mapped to ROs), such that the device may determine which ROs to use for performing a RACH procedure based on which SSBs are received and/or on which beams the SSBs are received. For example, the UE may receive multiple SSBs (e.g., via respective beams) and may initiate the RACH procedure in an RO that corresponds to an SSB and/or beam that is received with highest or best measured channel conditions (e.g., reference signal received power (RSRP), channel quality indicator (CQI), reference signal received quality (RSRQ), etc.). In some aspects, one or more first SSBs may be sent via a first beam from the network entity, and the one or more first SSBs and/or the first beam may correspond to one or more first ROs, such that a UE receiving the one or more first SSBs via the first beam may determine to use the one or more first ROs to perform a RACH procedure to connect to the network entity.

Accordingly, the adaptation of PRACH configurations in the spatial domain may include adding or removing one or more ROs and/or PRACH resources that are mapped to corresponding beamformed transmissions (e.g., beams carrying SSBs that correspond to ROs). For example, the network entity may adjust how many ROs or which ROs are mapped to the SSBs and/or corresponding beams. Subsequently, a UE receiving the SSBs via the corresponding beams may determine to use the adjusted ROs mapped to those SSBs and/or beams to perform a RACH procedure to connect to the network entity. Additionally or alternatively, the additional ROs may be adapted based on an adaptation of a periodicity of the additional ROs (e.g., adjusting how often the additional ROs occur), an adaptation of how many additional ROs are available (e.g., adjusting a quantity of the additional ROs), an adaptation at the PRACH configuration level or an association period level or an association pattern period level (e.g., adjusting additional parameters in a PRACH configuration), an adaptation of an SSB-to-RO mapping cycle (e.g., adjusting which SSBs map to which ROs in one or more cycles of mapping each SSB to a respective RO), an adaptation based on extending a cell discontinuous reception (DRX) operation for PRACH, concentrating ROs in the time-domain, and other options.

To identify which SSBs are mapped to which ROs, the UE may apply an SSB-RO mapping scheme and/or SSB-RO mapping rule using an association period, where the association period may represent a time period defined for mapping SSBs to ROs. For example, for the legacy ROs, an association period, starting from a frame 0, for mapping SSB indexes to ROs (e.g., PRACH occasions) may be the smallest value in a set (e.g., 1, 2, 4, 8, or 16 PRACH configuration periods) determined by a PRACH configuration period for the legacy ROs, such that each SSB index of a total number of SSB indexes

$$( e . g . , {N}_{T x}^{S S B} S S B indexes )$$

is mapped at least once to a legacy RO within the association period, where the UE obtains the indexes for each SSB of the total number of SSBs from a value in a system information block (SIB) (e.g., ssb-PositionInBurst value in a first SIB (SIB1)) or in a common configuration message (e.g., ServingCellConfigCommon message). For example, a PRACH configuration period may include a configurable (e.g., by a network entity) amount of time (e.g., 10, 20, 40, 80, or 160 milliseconds (ms)) according to a number of frames (e.g., 1, 2, 4, 8, or 16 frames, respectively). In some aspects, the network entity may indicate the PRACH configuration period(s) in the PRACH configuration(s) described above, and the network entity may configure one or more (or none) legacy ROs in each PRACH configuration period, such that the UE knows the location of the legacy ROs based on the PRACH configuration period(s) and other information included in the PRACH configuration(s).

If after an integer number of the SSB indexes-to-RO mapping cycles within the association period there is a set of legacy ROs or PRACH preambles that are not mapped to the total number of SSB indexes, no SSB indexes may be mapped to the set of legacy ROs or PRACH preambles. For example, a single SSB indexes-to-RO mapping cycle may include each SSB being mapped to a respective legacy RO based on values of the SSB indexes, and one or more SSB indexes-to-RO mapping cycles may occur in an association period, such that each SSB is mapped to multiple legacy ROs within the association period. However, the quantity of ROs that are mapped to/from each SSB must remain the same for all SSBs. As such, if there are leftover legacy ROs in an association period after each SSB has been mapped a same number of times to respective ROs as the other SSBs in the association period, where the leftover legacy ROs include a quantity of legacy ROs that is less than the total quantity of SSBs, then no SSBs may be mapped to the leftover ROs to ensure that the quantity of ROs that are mapped to/from each SSB is the same for all SSBs. An association period may include one or more association periods and may be determined so that a pattern between the legacy ROs and the SSB indexes repeats at most every 160 ms. ROs not associated with SSB indexes after an integer number of association periods, if any, may not be used for PRACH transmissions and/or RACH procedures.

That is, an association period may be defined such that each SSB of a total number of SSBs sent by a network entity is mapped consecutively at least once to a legacy RO within the association period based on the indexes of the SSBs. For example, a first SSB with a first SSB index value may be mapped to a first configured legacy RO within the association period, a second SSB with a second SSB index value may be mapped to a second configured legacy RO within the association period, etc., until each SSB of the total number of SSBs are mapped at least once to a corresponding configured legacy RO within the association period. In some aspects, the first SSB index value could be any index value, such as either the first SSB that is actually sent (e.g., may not have a configured index value of ‘0’) or an offset from the first sent SSB index.

Subsequently, the SSBs may be mapped to the configured legacy ROs in an association period in the order in which the SSBs are received, where the mapping resets and is performed again for a next association period using the above described techniques. That is, a plurality of SSBs may be mapped to at least a first set of legacy ROs in a first association period and a second set of legacy ROs in a second association period. Additionally, for each of the first association period and the second association period, the plurality of SSBs may be mapped starting at a lowest SSB index value (e.g., the first SSB index value described above). Following these rules, the SSB-RO mapping for the legacy ROs may be balanced or uniform, such that a same number of legacy ROs per SSB are mapped in each association period. As described herein, the association period(s) for the legacy ROs may be referred to as legacy association period(s).

In some aspects, for the case where legacy ROs and additional ROs overlap in neither the time domain nor frequency domain, for adaptation of PRACH in time domain, the SSB-RO mapping rule for the additional ROs may follow the legacy SSB-RO mapping rule described above. For example, mapping SSB indexes to valid additional ROs provided by semi-static signaling may follow the legacy mapping order for preamble, time resource, frequency, and/or PRACH slot indexes. In some aspects, this mapping may not be impacted by time domain PRACH adaptation. Additionally, validation rules for the additional ROs may follow the legacy validation rules for the legacy ROs configured for legacy UEs.

One or more technical problems arise when both legacy ROs and additional ROs are configured for RACH procedures. For example, SSB-RO mapping may be performed separately for the additional ROs and the legacy ROs. The association period described above was introduced for the legacy ROs to ensure that the number of legacy ROs that map to SSBs is uniform for each reference period (e.g., association period). However, with the additional ROs, there may be more difficulties maintaining two separate association periods. Additionally, if the legacy association period is relied upon for an SSB-RO mapping for the additional ROs, there may be challenges on how the SSB-RO mapping will be performed for the additional ROs.

The techniques and signaling described herein provide a technical solution for an SSB-RO mapping for the additional ROs. For example, one or more SSBs may be mapped to one or more additional ROs according to a legacy association period. That is, the one or more SSBs may be mapped to one or more additional ROs based on the above described rules for an association period for legacy ROs, such that the SSB-RO mapping for the additional ROs resets between association periods defined for the legacy ROs. Additionally or alternatively, the one or more SSBs may be mapped to respective additional ROs irrespective of the legacy association period(s) for the legacy ROs to ensure that each SSB has been mapped at least once to a respective additional RO, and the mapping does not reset based on the legacy association period(s). Additionally or alternatively, the one or more SSBs may be mapped to one or more additional ROs based on additional association period(s) defined for the additional ROs, where the additional association period(s) may differ in length and/or periodicity compared to the legacy ROs. Subsequently, the mapping of the one or more SSBs to the one or more additional ROs may reset between the additional association period(s).

The techniques for performing the SSB-RO mapping for the additional ROs as described herein may provide any of various beneficial technical effects and/or advantages. For example, the SSB-RO mapping for the additional ROs may define how SSBs are mapped to the additional ROs to enable a UE to determine which additional RO to potentially use for a RACH procedure based on a received SSB. Subsequently, a higher quantity of ROs may be made available to the UE via the additional ROs to perform the RACH procedure, which may increase reliability for communications. For example, increasing the quantity of available ROs may increase a likelihood that UEs can successfully perform respective RACH procedures.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

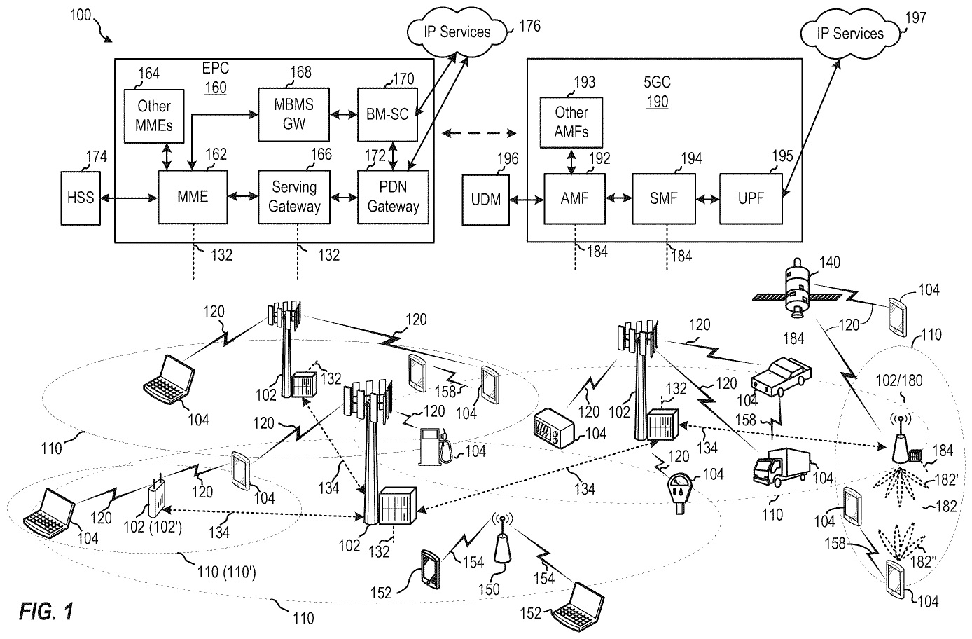

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

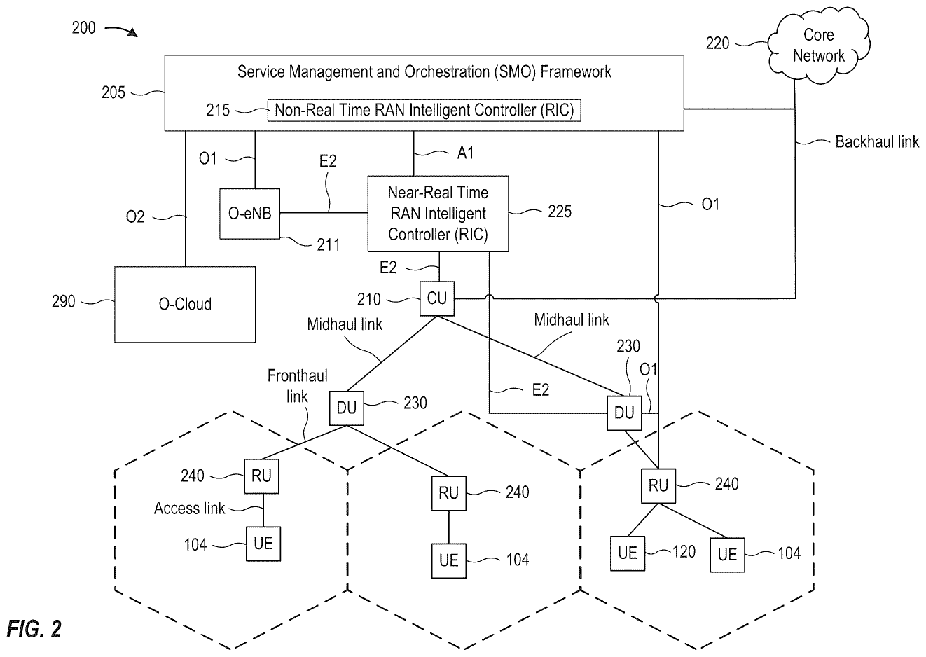

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

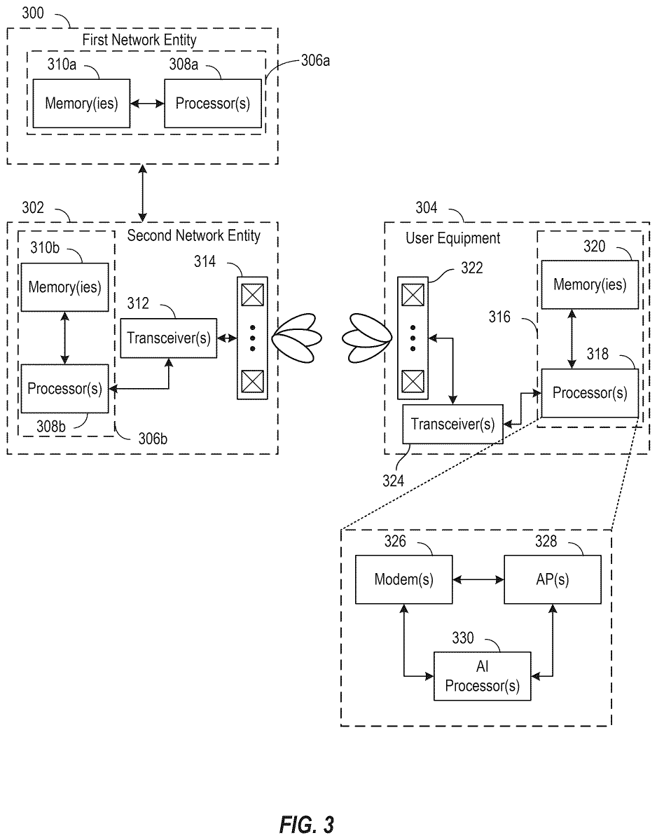

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

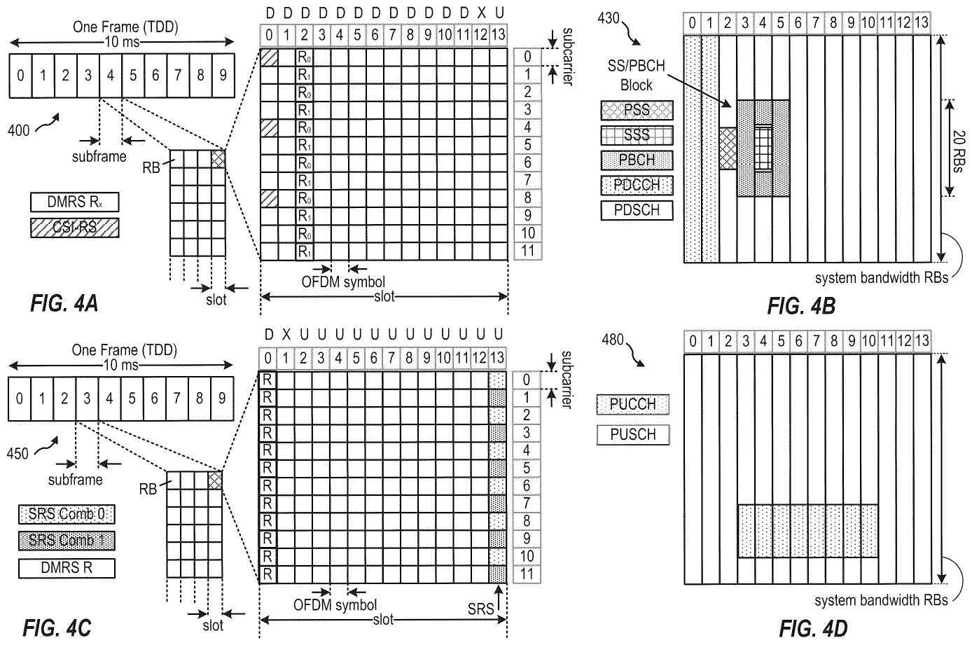

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 24 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Random Access Procedures

Certain wireless communication systems (e.g., a 5G NR system and/or any future wireless communications system) may provide a specified channel for random access, such as a RACH, and corresponding random access procedures. A random access procedure may be performed for any of various events including, for example, initial access from an idle state (e.g., RRC idle), RRC connection re-establishment, handover, DL and/or UL data arrival (e.g., when the UE is in an idle state), or device positioning.

FIG. 5A depicts a process flow diagram of an example four-step RACH procedure 500A performed between a UE 504 and a network entity 502. In some aspects, the UE 504 may represent the UE 104 depicted and described with respect to FIG. 1 or the UE 304 depicted and described with respect to FIG. 3. In some aspects, the network entity 502 may represent the BS 102 depicted and described with respect to FIG. 1, the first network entity 300 or the second network entity 302 depicted and described with respect to FIG. 3, or a disaggregated base station depicted and described with respect to FIG. 2.

The four-step RACH procedure 500A may optionally begin at 506, where the network entity 502 broadcasts and the UE 504 receives a random access configuration, for example, in system information within an SSB, or within an RRC message. The random access configuration may indicate or include one or more parameters for random access communications, such as defining the RACH, the number of random access preambles (e.g., preamble sequences) available for random access, power ramping parameters, response window size (duration), etc. In certain aspects, the UE 504 may obtain an indication of a modification to the random access configuration.

At 508, the UE 504 sends a first message (MSG1) to the network entity 502 on a PRACH. In certain aspects, MSG1 may indicate or include a RACH preamble. The RACH preamble may be or include a preamble sequence (e.g., a Zaddoff Chu sequence). For contention-based random access, the preamble sequence may be randomly selected among a set of preamble sequences (e.g., up to 64 sequences, in some cases). The preamble sequence may be used to identify the UE 504 for scheduling communications (e.g., MSG2 and MSG3) with the network entity. In certain aspects, terms such as “RACH preamble,” “random access preamble,” “preamble,” “preamble sequence,” “sequence,” and the like may be used interchangeably.

At 510, the network entity 502 may respond with a random access response (RAR) message (MSG2). For example, the network entity 502 may send a PDCCH communication including downlink control information (DCI) that schedules the RAR on the PDSCH. The RAR may include, for example, certain parameters used for an uplink transmission such as a random access (RA) preamble identifier (RAPID), a timing advance, an uplink (UL) grant (e.g., indicating one or more time-frequency resources for an uplink transmission), cell radio network temporary identifier (C-RNTI), and/or a backoff parameter value. The RAPID may correspond to the preamble sequence and indicate that the RAR is for the UE 504 that transmitted MSG1 at 506. The backoff parameter value may be used to determine a RACH occasion (RO) for sending a subsequent RACH transmission (e.g., a preamble transmission). A RACH occasion may correspond to one or more time-frequency resources available for transmitting a preamble in a RACH.

At 512, in response to MSG2, the UE 504 transmits a third message (MSG3) to the network entity 502 on the PUSCH. In some aspects, MSG3 may include an RRC connection request, a tracking area update (e.g., for UE mobility), and/or a scheduling request (for an UL transmission). As an example, MSG3 is communicated in the time-frequency resource(s) indicated in the UL grant of the RAR.

At 514, the network entity 502 may send a contention resolution message (MSG4) in response to MSG3. In certain cases, multiple UEs may send the same preamble in the same RO. As the network entity 502 may not be able to identify which UE sent which preamble, the network entity 502 may reply with a single RAR associated with the preamble. The MSG3 may include or indicate a specific UE identity associated with the UE 504, such as a radio network temporary identifier (RNTI) or a temporary mobile subscriber identity (TMSI). The network entity 502 may decode MSG3 and determine the UE identity associated with at least one of the UEs (e.g., UE 504). MSG4 may be addressed to the UE identity (e.g., the RNTI or an RNTI based on the TMSI) associated with the MSG3 that the network entity was able to successfully decode. For example, the MSG4 may be scrambled by the RNTI associated with the MSG3. If the UE 504 obtains the same identity sent in MSG3, the UE 504 concludes that the random procedure succeeded. In some cases, if the UE 504 is unable to obtain or decode MSG3 and/or MSG4, the UE 504 may repeat the RACH procedure, such as the four-step RACH procedure 500A.

In some cases, to reduce the latency associated with random access, a two-step RACH procedure may be used. As the name implies, the two-step RACH procedure may effectively consolidate the four messages of the four-step RACH procedure into two messages.

FIG. 5B depicts a process flow diagram of an example two-step RACH procedure 500B performed between the UE 504 and the network entity 502.

The two-step RACH procedure 500B may optionally begin at 550, where the network entity 502 broadcasts and the UE 504 receives a random access configuration, for example in system information within an SSB, or within an RRC message.

At 552, the UE 504 sends a first message (MSGA) to the network entity 502, which may effectively combine MSG1 and MSG3 described above with respect to FIG. 5A. In some aspects, MSGA includes a RACH preamble for random access and a payload. For example, the payload may include a UE-ID and other signaling information, such as a buffer status report or scheduling request. The RACH preamble of MSGA may be transmitted over the RACH, and the payload of MSGA may be transmitted over the PUSCH, for example.

At 554, the network entity 502 may send a random access response message (MSGB), which may effectively combine MSG2 and MSG4 described above. For example, MSGB may include a RAPID, a timing advance, a backoff parameter value, a contention resolution message, an uplink and/or downlink grant, and transmit power control commands.

### Example SSB-to-RO Mapping Schemes

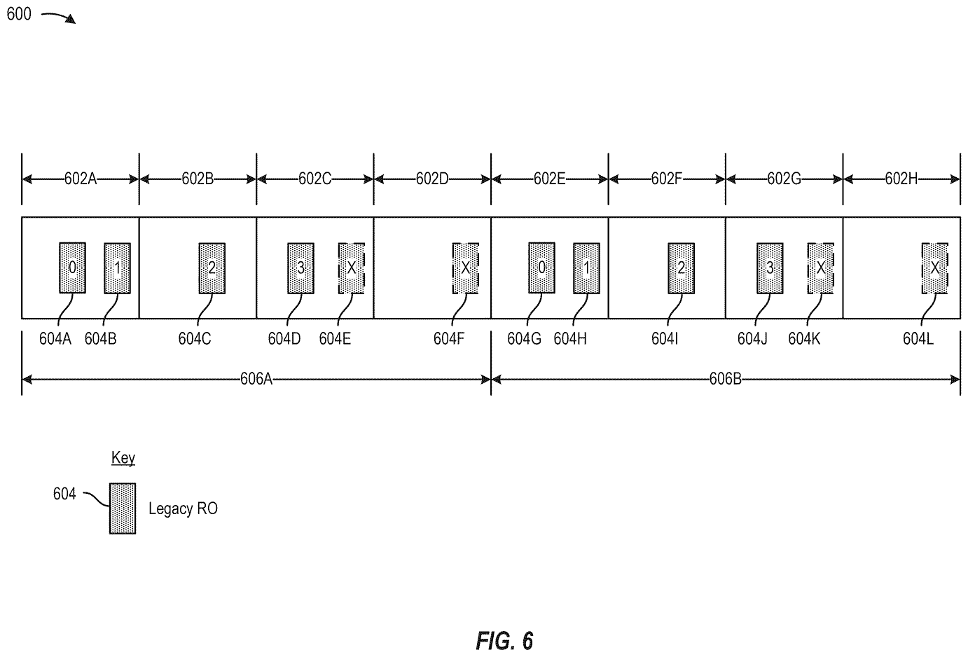

FIG. 6 depicts an example association period configuration 600 for an SSB-RO mapping scheme for legacy ROs. In some aspects, the association period configuration 600 may implement aspects of or may be implemented by aspects of FIGS. 1-5B. For example, a UE may employ the association period configuration 600 when mapping one or more SSBs (e.g., received from a network entity) to one or more legacy ROs 604, where the UE can use the one or more legacy ROs 604 for performing a RACH procedure, such as the four-step RACH procedure 500A depicted and described with respect to FIG. 5A and/or the two-step RACH procedure 500B depicted and described with respect to FIG. 5B. In some aspects, the UE may represent the UE 104 depicted and described with respect to FIG. 1, the UE 304 depicted and described with respect to FIG. 3, or the UE 504 depicted and described with respect to FIGS. 5A and 5B. In some aspects, the network entity may represent an example of the BS 102 depicted and described with respect to FIG. 1, the first network entity 300 or the second network entity 302 depicted and described with respect to FIG. 3, a disaggregated base station depicted and described with respect to FIG. 2, or the network entity 502 depicted and described with respect to FIGS. 5A and 5B.

In some aspects, the UE may obtain a PRACH configuration from the network entity (e.g., via broadcasted system information) that indicates parameters for the UE to perform the RACH procedure. For example, the legacy PRACH configuration may indicate a set of preambles, one or more PRACH configuration periods 602, a periodicity for the legacy ROs 604, a duration for the RAR window, etc., to enable the UE to perform the RACH procedure. Subsequently, the UE may determine time-frequency resources that are configured for the legacy ROs 604 in the one or more PRACH configuration periods 602 based on the parameters indicated in the PRACH configuration.

In some aspects, the UE may obtain one or more SSBs from the network entity. For example, the network entity may indicate a quantity of SSBs that the UE should monitor for and/or expect to receive from the network entity, where, in certain aspects, the quantity of SSBs is indicated via a value in a SIB (e.g., ssb-PositionInBurst value in a SIB1) or in a common configuration message (e.g., ServingCellConfigCommon message). Additionally, the network entity may also indicate respective index values for each of the SSBs, such as via the value in the SIB or in the common configuration message. In some aspects, the network entity may send the one or more SSBs to UEs located in a coverage area of the network entity, where the one or more SSBs are sent via respective beams. In the example of FIG. 6, the network entity may send four SSBs, where a first SSB is configured with an index value of ‘0,’ a second SSB is configured with an index value of ‘1,’ a third SSB is configured with an index value of ‘2,’ and a fourth SSB is configured with an index value of ‘3.’ Additionally or alternatively, the network entity may send a different quantity of SSBs, such as eight SSBs or 64 SSBs. The SSBs may include synchronization signals, reference signals (e.g., DMRSs), and/or broadcasted data to enable the UE to establish a connection with the network entity.

The SSBs and corresponding beams may be associated with one or more respective ROs, such that the UE may determine which legacy ROs 604 to use for performing the RACH procedure based on which SSBs are received and/or on which beams the SSBs are received. For example, the UE may apply an SSB-RO mapping scheme to determine which SSBs map to which legacy RO 604. For mapping the one or more SSBs to the legacy ROs 604, the UE may use one or more association periods 606, where each association period 606 includes one or more PRACH configuration periods 602. For example, an association period 606 may be defined as a smallest integer number of {1, 2, 4, 8, or 16} PRACH configuration periods 602 that has all of the one or more SSBs mapped at least once to respective legacy ROs 604.

In the example of FIG. 6, the UE may determine a first association period 606A includes four PRACH configuration periods 602, such as a first PRACH configuration period 602A, a second PRACH configuration period 602B, a third PRACH configuration period 602C, and a fourth PRACH configuration period 602D. For example, the UE may determine the first association period 606A includes the four PRACH configuration periods 602 based on consecutively mapping each of the four SSBs at least once to respective legacy ROs 604 in the first association period 606A. That is, the UE may consecutively map the first SSB configured with the index value of ‘0’ to a first legacy RO 604A in the first PRACH configuration period 602A, the second SSB configured with the index value of ‘1’ to a second legacy RO 604B in the first PRACH configuration period 602A, the third SSB configured with the index value of ‘2’ to a third legacy RO 604C in the second PRACH configuration period 602B, and the fourth SSB configured with the index value of ‘3’ to a fourth legacy RO 604D in the third PRACH configuration period 602C. In some aspects, a first SSB index value of consecutive SSBs could be any index value, such as either a first SSB that is actually sent (e.g., may not have a configured index value of ‘0’) or an offset from the first sent SSB index. Additionally, the above described mapping may represent a single SSB-RO mapping cycle based on each SSB being mapped at least once to a respective legacy RO 604.

Accordingly, based on the fourth legacy RO 604D not occurring until the third PRACH configuration period 602C, the UE may determine the first association period 602A includes the four PRACH configuration periods 602 because the UE selects a quantity of PRACH configuration periods 602 from the set of {1, 2, 4, 8, or 16} PRACH configuration periods 602 for the first association period 606A. For example, the first PRACH configuration period 602A may not include all of the SSBs being mapped to respective legacy ROs 604 (e.g., for the option of one PRACH configuration period 602 from the set), and the combination of the first PRACH configuration period 602A and the second PRACH configuration period 602B may also not include all of the SSBs being mapped to respective legacy ROs 604 (e.g., for the option of two PRACH configuration periods 602 from the set). Subsequently, the UE may then determine that the next available option of four PRACH configuration periods 602 from the set does include all of the SSBs being mapped to respective legacy ROs 604 and, as such, may determine the first association period 606A includes the four PRACH configuration periods 602, even though all of the SSBs are mapped at least once using three PRACH configuration periods 602.

In some aspects, after each SSB of a total quantity of SSBs (e.g., four SSBs in the example of FIG. 6) are mapped at least once to respective legacy ROs 604 in an association period 606, one or more legacy ROs 604 may still be configured within the association period 606. For example, in the first association period 606A, a fifth legacy RO 604E may be configured in the third PRACH configuration period 602C, and a sixth legacy RO 604F may be configured in the fourth PRACH configuration period 602D. However, the UE may not map any of the SSBs and/or SSB indexes to the fifth legacy RO 604E or the sixth legacy RO 604F, and the UE may not be allowed to use the fifth legacy RO 604E or the sixth legacy RO 604F for the RACH procedure. For example, if after an integer number of the SSB-RO mapping cycles (e.g., the single SSB-RO mapping cycle described above) within an association period 606 there is a set of legacy ROs 604 (e.g., the fifth legacy RO 604E and the sixth legacy RO 604F) that are not mapped to SSB indexes, no SSB indexes may be mapped to the set of legacy ROs 604.

After the first association period 606A ends (e.g., after the fourth PRACH configuration period 602D), the UE may reset the SSB-RO mapping for a second association period 606B. That is, the UE may restart the consecutive mapping of SSBs to respective legacy ROs 604 when determining a quantity of PRACH configuration periods 604 for the second association period 606B. For example, after the first association period 606A ends, the UE may restart the consecutive mapping of SSBs to respective legacy ROs 604, such that the first SSB configured with the index value of ‘0’ is mapped to a seventh legacy RO 604G in a fifth PRACH configuration period 602E, the second SSB configured with the index value of ‘1’ is mapped to an eighth legacy RO 604H in the fifth PRACH configuration period 602E, the third SSB configured with the index value of ‘2’ is mapped to a ninth legacy RO 604I in a sixth PRACH configuration period 602F, and the fourth SSB configured with the index value of ‘3’ is mapped to a tenth legacy RO 604J in a seventh PRACH configuration period 602G. As described above, an index value for the first SSB could be any index value, such as either the first SSB that is actually sent (e.g., may not have a configured index value of ‘0’) or an offset from the first sent SSB.

Accordingly, similar to the first association period 606A, the UE may determine the second association period 606B also includes four PRACH configuration periods 602 based on each SSB being mapped at least once to a respective legacy RO 604 across the four PRACH configuration periods 602. For example, the four PRACH configuration periods for the second association period 606B may include the fifth PRACH configuration period 602E, the sixth PRACH configuration period 602F, the seventh PRACH configuration period 602G, and an eighth PRACH configuration period 602H based on the UE selecting the quantity of PRACH configuration periods 602 for the second association period 606B from the set of {1, 2, 4, 8, or 16} PRACH configuration periods 602.

Additionally, after each SSB is mapped at least once in the second association period 606B, an eleventh legacy RO 604K may be configured in the seventh PRACH configuration period 602G, and a twelfth legacy RO 604L may be configured in the eighth PRACH configuration period 602H. However, similar to the fifth legacy RO 604E and the sixth legacy RO 604F configured in the first association period 606A, the UE may not map any of the SSBs and/or SSB indexes to the eleventh legacy RO 604K and the twelfth legacy RO 604L, and the UE may not be allowed to use the eleventh legacy RO 604K or the twelfth legacy RO 604L for the RACH procedure.

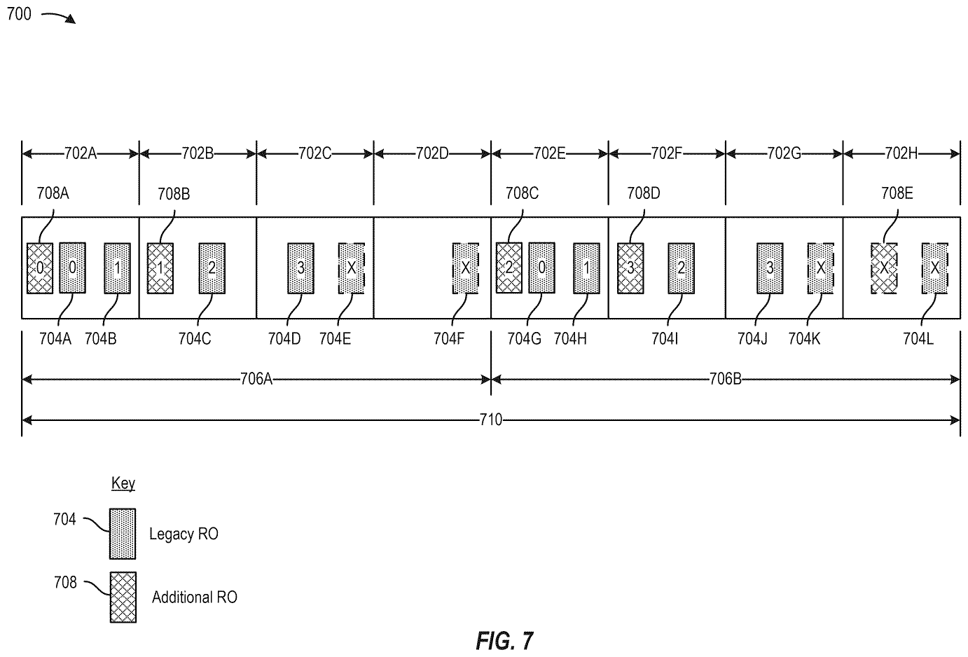

FIG. 7 depicts example association period configurations 700 for an SSB-RO mapping scheme for legacy ROs and additional ROs. In some aspects, the association period configurations 700 may implement aspects of or may be implemented by aspects of FIGS. 1-6. For example, a UE may employ the association period configurations 700 when mapping one or more SSBs (e.g., received from a network entity) to one or more legacy ROs 704 and one or more additional ROs 708, where the UE can use the one or more legacy ROs 604 and/or the one or more additional ROs 708 for performing a RACH procedure, such as the four-step RACH procedure 500A depicted and described with respect to FIG. 5A and/or the two-step RACH procedure 500B depicted and described with respect to FIG. 5B. In some aspects, the UE may represent the UE 104 depicted and described with respect to FIG. 1, the UE 304 depicted and described with respect to FIG. 3, or the UE 504 depicted and described with respect to FIGS. 5A and 5B. In some aspects, the network entity may represent an example of the BS 102 depicted and described with respect to FIG. 1, the first network entity 300 or the second network entity 302 depicted and described with respect to FIG. 3, a disaggregated base station depicted and described with respect to FIG. 2, or the network entity 502 depicted and described with respect to FIGS. 5A and 5B.

In some aspects, the association period configurations 700 may include the association period configuration 600 depicted and described with respect to FIG. 6. For example, the UE may obtain a first PRACH configuration (e.g., the PRACH configuration described with respect to FIG. 6) that indicates the one or more legacy ROs 704, such that the first PRACH configuration may be referred to as a legacy PRACH configuration. Additionally, the UE may map SSBs (e.g., a first plurality of SSBs) to the legacy ROs 704 as described and depicted with respect to FIG. 6. For example, the UE may determine a first association period 706A that includes a first SSB (e.g., with a first SSB index value, such as ‘0’) mapped to a first legacy RO 704A, a second SSB (e.g., with a second SSB index value, such as ‘1’) mapped to a second legacy RO 704B, a third SSB (e.g., with a third SSB index value, such as ‘2’) mapped to a third legacy RO 704C, and a fourth SSB (e.g., with a fourth SSB index value, such as ‘3’) mapped to a fourth legacy RO 704D, and the first association period 706A may include a first PRACH configuration period 702A, a second PRACH configuration period 702B, a third PRACH configuration period 702C, and a fourth PRACH configuration period 702D. The first association period 706A may also include a fifth legacy RO 704E and a sixth legacy RO 704F that are not mapped to any SSB index, and the UE may not be allowed to use the fifth legacy RO 704E or the sixth legacy RO 704F for the RACH procedure.

Additionally, the UE may determine a second association period 706B that includes the first SSB mapped to a seventh legacy RO 704G, the second SSB mapped to an eighth legacy RO 704H, the third SSB mapped to a ninth legacy RO 704I, and the fourth SSB mapped to a tenth legacy RO 704J, and the second association period 706B may include a fifth PRACH configuration period 702E, a sixth PRACH configuration period 702F, a seventh PRACH configuration period 702G, and an eighth PRACH configuration period 702H. The second association period 706B may also include an eleventh legacy RO 704K and a twelfth legacy RO 704L that are not mapped to any SSB index, and the UE may not be allowed to use the eleventh legacy RO 704K or the twelfth legacy RO 704L for the RACH procedure.

In the example of FIG. 7, the UE may obtain a second PRACH configuration that indicates the one or more additional ROs 708. In some aspects, the UE may determine a third association period 710 for mapping SSBs to the one or more additional ROs 708. For example, the third association period 710 may differ in length compared to the first association period 706A and/or the second association period 706B. Additionally or alternatively, a periodicity of association period(s) (e.g., association pattern period for SSB-RO mapping for the additional ROs) may be defined separately for the additional ROs than for a periodicity of the association period(s) defined for the legacy ROs. In some aspects, the UE may map the same SSBs (e.g., the first plurality of SSBs) to the one or more additional ROs 708 as the SSBs mapped to the legacy ROs 704 described above. Additionally or alternatively, the network entity may send one or more additional SSBs (e.g., a second plurality of SSBs), and the UE may map the one or more additional SSBs to the one or more additional ROs 708.

Similar to the SSB-RO mapping scheme used by the UE to map the SSBs to the legacy ROs 704, the UE may map the SSBs (e.g., either the first plurality of SSBs or the second plurality of SSBs) consecutively to the one or more additional ROs 708 when determining the third association period 710. For example, for the third association period 710, the UE may map a first SSB configured with an SSB index value of ‘0’ to a first additional RO 708A in the first PRACH configuration period 702A, a second SSB configured with an SSB index value of ‘1’ to a second additional RO 708B in the second PRACH configuration period 702B, a third SSB configured with an SSB index value of ‘2’ to a third additional RO 708C in the fifth PRACH configuration period 702E, and a fourth SSB configured with an SSB index value of ‘3’ to a fourth additional RO 708D in the sixth PRACH configuration period 702F. In some aspects, similar to the SSB-RO mapping scheme for the legacy ROs 704, the index value configured for the first SSB could be any index value, such as either the first SSB that is actually sent (e.g., may not have a configured index value of ‘0’) or an offset from the first sent SSB. Additionally, while four SSBs are mapped to the additional ROs 708 in the example of FIG. 7, the network entity may send a different number of SSBs, such as eight SSBs or 64 SSBs.

In some aspects, the UE may determine a quantity of PRACH configuration periods 702 for the third association period 710 similar to how the UE determines the quantity of PRACH configuration periods 702 for the first association period 706A and the second association period 706B. For example, the UE may select the quantity of PRACH configuration periods 702 for the third association period 710 from the set of {1, 2, 4, 8, or 16} PRACH configuration periods based on whether each SSB has been mapped at least once to respective additional ROs 708. Accordingly, the UE may determine the third association period 710 includes the eight PRACH configuration periods 702 based on the fourth SSB being mapped to the fourth additional RO 708D after the fourth PRACH configuration period 702D and before the eighth PRACH configuration period 702H (e.g., the fourth additional RO 708D is configured in the sixth PRACH configuration period 702F).

Additionally, the third association period 710 may include a fifth additional RO 708E configured in the eighth PRACH configuration period 702H. In some aspects, similar to the legacy ROs 704 and based on each SSB being mapped at least once to respective additional ROs 708 in the third association period 710, the UE may not map any SSB index to the fifth additional RO 708E, and the UE may not be allowed to use the eleventh legacy RO 704K or the twelfth legacy RO 704L for the RACH procedure.

While not shown in the example of FIG. 7, the UE may restart the mapping of the SSBs to the additional ROs 708 for a subsequent association period after the third association period 710. Additionally or alternatively, while the third association period 710 is defined for mapping the SSBs to the additional ROs 708, the third association period 710 and/or an association pattern period (e.g., a repetition period for a pattern of association periods between SSBs and ROs, which may include a maximum duration of 160 ms) may not be separately defined for the additional ROs 708. For example, the UE may not maintain two different association period configurations for the legacy ROs 704 and for the additional ROs 708, and the SSB-RO mapping of the additional ROs 708 may depend on the association period(s) defined for the legacy ROs 704. However, different logic may be used and/or defined for mapping the SSBs to the additional ROs 708 for the association period(s) defined for the legacy ROs 704. Additionally or alternatively, if the third association period 710 (e.g., along with additional association period(s)) is defined for the additional ROs 708, the UE may use same logic of SSB-RO mapping as the legacy ROs 704, but the UE may maintain two different association periods.

### Aspects Related to SSB-to-RO Mapping Schemes for Additional ROs

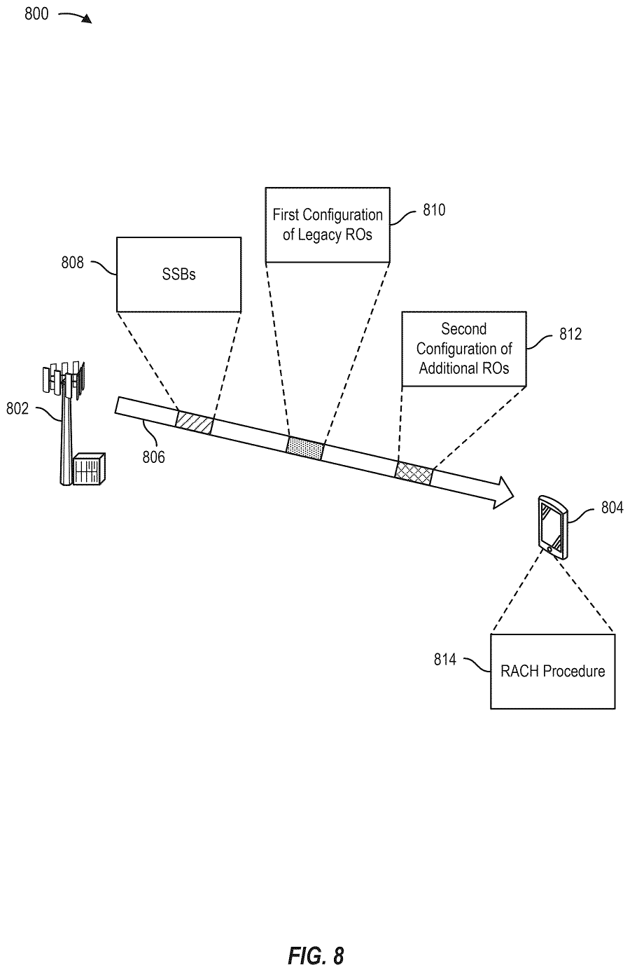

FIG. 8 depicts an example wireless communications system 800 for performing a RACH procedure based on an SSB-to-RO mapping scheme for additional ROs in accordance with aspects of the present disclosure. In some aspects, the wireless communications system 800 may implement aspects of or may be implemented by aspects of FIGS. 1-7. For example, the wireless communications system 800 may include a network entity 802 and at least one UE 804. In some aspects, the network entity 802 may represent an example of the BS 102 depicted and described with respect to FIG. 1, the first network entity 300 or the second network entity 302 depicted and described with respect to FIG. 3, a disaggregated base station depicted and described with respect to FIG. 2, or the network entity 502 depicted and described with respect to FIGS. 5A and 5B. In some aspects, the UE 804 may represent the UE 104 depicted and described with respect to FIG. 1, the UE 304 depicted and described with respect to FIG. 3, or the UE 504 depicted and described with respect to FIGS. 5A and 5B. Additionally, the network entity 802 and the UE 804 may wirelessly communicate via a communication link 806 (e.g., one or more carriers, a communication link 120, beamforming 182, etc.). While only one (1) UE 804 is depicted in the example of FIG. 8, the network entity 802 may communicate with multiple UEs and/or devices.

In some aspects, the network entity 802 may periodically send (e.g., broadcast) a plurality of SSBs 808, and the UE 804 may obtain the plurality of SSBs 808 (e.g., via the communication link 806). For example, the network entity 802 may send each SSB of the plurality of SSBs 808 via respective beams (e.g., beamformed transmissions), and the UE 804 may obtain each SSB via a respective beam. Additionally, the network entity 802 may configure a respective SSB index value for each SSB of the plurality of SSBs 808, such as via a value in a SIB (e.g., ssb-PositionInBurst value in a SIB1) or in a common configuration message (e.g., ServingCellConfigCommon message).

Subsequently, the UE 804 may determine how many SSBs the network entity 802 is sending based on the value in the SIB or the common configuration message. For example, the network entity 802 may send four SSBs or eight SSBs (e.g., for communications in FR1) or 64 SSBs (e.g., for communications in FR2).

The plurality of SSBs 808 may include synchronization signals (e.g., PSS and SSS), reference signals (e.g., PBCH DMRS(s)), and broadcasted data (e.g., via a PBCH) to enable the UE 804 to establish a connection with the network entity 802. Additionally, the UE 804 may measure a signal strength of each SSB of the plurality of SSBs 808 that the UE 804 detects for a certain period (e.g., a period of one SSB set that includes the plurality of SSBs 808). From the measurement results, the UE 804 may identify an SSB index value, such as with a strongest signal strength and/or a beam with the strongest signal strength that corresponds to the identified SSB index value. Subsequently, the UE 804 may determine an RO that corresponds to the identified SSB index value for performing a RACH procedure to establish the connection with the network entity 802 (e.g., also using the information included in the SSB that corresponds to the identified SSB index value). For example, as described herein, the UE 804 may perform an SSB-RO mapping to determine the RO that corresponds to the identified SSB index value.

In some aspects, the network entity 802 may send and the UE 804 may obtain a first configuration 810 (e.g., via the communication link 806), where the first configuration 810 indicates a plurality of legacy ROs (e.g., the legacy ROs 604 depicted and described with respect to FIG. 6 and/or the legacy ROs 704 depicted and described with respect to FIG. 7). Accordingly, the UE 804 may map the plurality of SSBs 808 to a set of legacy ROs of the plurality of legacy ROs. For example, the set of legacy ROs may at least include a first set of legacy ROs in a first association period and a second set of legacy ROs in a second association period. Additionally, as depicted and described with respect to FIGS. 6 and 7, for each of the first association period and the second association period, the plurality of SSBs 808 may be mapped starting at a first SSB index value or lowest SSB index value (e.g., the SSB-RO mapping for the set of legacy ROs resets between the first association period and the second association period). As described with respect to FIGS. 6 and 7, the first SSB index value could be any index value, such as either an SSB index value for the first SSB that is actually sent (e.g., may not have a configured SSB index value of ‘0’) or an offset from the SSB index value for the first sent SSB.

Additionally, the network entity 802 may send and the UE 804 may obtain a second configuration 812 (e.g., via the communication link 806), where the second configuration 812 indicates a plurality of additional ROs (e.g., the additional ROs 708 depicted and described with respect to FIG. 7). Accordingly, the UE 804 may map one or more SSBs of the plurality of SSBs 808 or one or more SSBs of a second plurality of SSBs to a set of additional ROs of the plurality of additional ROs. For example, the UE 804 may map one or more SSBs of the plurality of SSBs 808 to the set of additional ROs, where the plurality of SSBs 808 is used for mapping to both the set of legacy ROs and the set of additional ROs. Additionally or alternatively, the network entity 802 may periodically send (e.g., broadcast) the second plurality of SSBs, where the second plurality of SSBs is used for mapping to the set of additional ROs alone. In some aspects, the second plurality of SSBs may include a same quantity of SSBs or a different quantity of SSBs than the plurality of SSBs 808.

In some aspects, the UE 804 may perform an SSB-RO mapping for the set of additional ROs based on whether association period(s) are defined for the set of additional ROs, such as the third association period 710 depicted and described with respect to FIG. 7. For example, the network entity 802 may send and the UE 804 may obtain an indication (e.g., via the communication link 806) that the association period(s) defined for the set of additional ROs are to be used for mapping the one or more SSBs (e.g., of the plurality of SSBs 808 or the second plurality of SSBs) to the set of additional ROs. In some aspects, the indication may be sent and obtained via at least one of: the second configuration 812, semi-static signaling, a SIB (e.g., SIB1), or RRC signaling.

In some aspects, if the association period(s) are not defined and/or are not indicated to be maintained for the set of additional ROs, the UE 804 may perform the SSB-RO mapping for the set of additional ROs using association period(s) defined for the set of legacy ROs (e.g., the first association period and the second association period described above). For example, the set of additional ROs may include a first set of additional ROs in the first association period and a second set of additional ROs in the second association period. Similar to the SSB-RO mapping for the set of legacy ROs, for each of the first association period and the second association period, the UE 804 may map the one or more SSBs of the plurality of SSBs or the second plurality of SSBs to the respective sets of additional ROs starting at the first SSB index value or the lowest SSB index value (e.g., the SSB-RO mapping for the set of additional ROs resets between the first association period and the second association period).

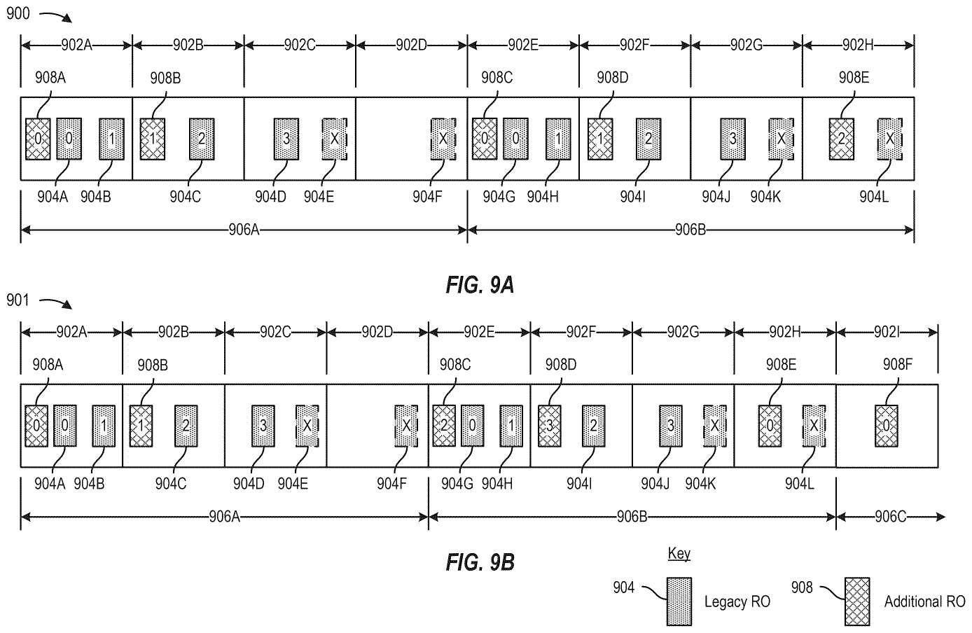

In some aspects, the UE 804 may reset the SSB-RO mapping for the set of additional ROs between the first association period and the second association period regardless of whether all SSBs of the plurality of SSBs 808 or the second plurality of SSBs have been mapped to the first set of additional ROs. For example, the UE 804 may map a subset (e.g., the one or more SSBs) of the plurality of SSBs 808 or the second plurality of SSBs in the first association period, but the UE 804 may still reset the SSB-RO mapping for the set of additional ROs in the second association period, such that the UE 804 maps the SSB with the first SSB index value or the lowest SSB index value to a first additional RO that is configured in the second association period. In such aspects, the first association period and second association period may be adjacent in time. This SSB-RO mapping for the set of additional ROs is depicted and described in greater detail with respect to FIG. 9A.

Additionally or alternatively, the UE 804 may reset the SSB-RO mapping for the set of additional ROs between the first association period and the second association period after all SSBs of the plurality of SSBs 808 or the second plurality of SSBs have been mapped to the first set of additional ROs. In such aspects, the first association period and the second association period may be separated in time by at least a third association period. For example, the UE 804 may not map all SSBs of the plurality of SSBs 808 or the second plurality of SSBs to the first set of additional ROs in the first association period. Accordingly, the UE 804 may collectively map all SSBs of the plurality of SSBs 808 or the second plurality of SSBs to the first set of additional ROs in the first association period and to a third set of additional ROs in the at least the third association period.

Subsequently, the UE 804 may then map the one or more SSBs of the plurality of SSBs 808 or the second plurality of SSBs starting at the first SSB index or the lowest SSB index value in the second association period based on all SSBs of the plurality of SSBs 808 or the second plurality of SSBs being mapped collectively to the first set of additional ROs in the first association period and to the third set of additional ROs in the at least the third association period. For example, the UE may reset the SSB-RO mapping in the second association period based on all SSBs being previously mapped across the first association period and the at least the third association period. This SSB-RO mapping for the set of additional ROs is depicted and described in greater detail with respect to FIG. 9B. Additionally or alternatively, the UE 804 may map all SSBs of the plurality of SSBs 808 or the second plurality of SSBs to the first set of additional ROs in the first association period, such that the SSB-RO mapping is reset for the second association period and the at least third association period is not used.

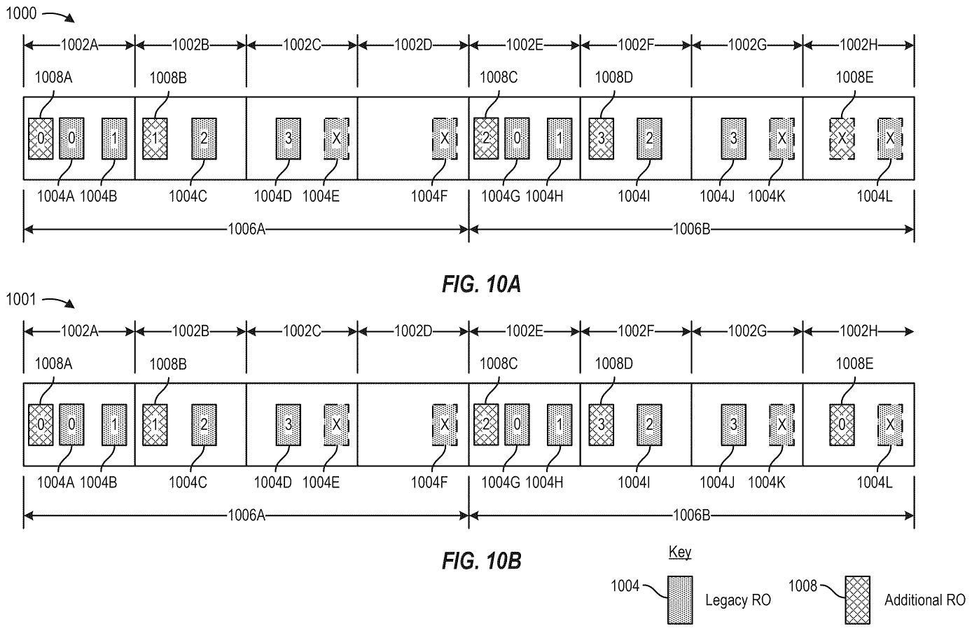

Additionally or alternatively, if the association period(s) are not defined and/or are not indicated to be maintained for the set of additional ROs, the UE 804 may perform the SSB-RO mapping for the set of additional ROs irrespective of the association period(s) defined for the set of legacy ROs (e.g., first association period and the second association period). For example, the UE 804 may perform the SSB-RO mapping for the set of additional ROs until all SSBs of the plurality of SSBs 808 or the second plurality of SSBs are mapped at least once across one or more association period(s) defined for the set of legacy ROs. This SSB-RO mapping for the set of additional ROs is depicted and described in greater detail with respect to FIGS. 10A and 10B. In some aspects, after all SSBs of the plurality of SSBs 808 or the second plurality of SSBs are mapped at least once across one or more association period(s) defined for the set of legacy ROs, the SSB-RO mapping for the set of additional ROs may reset at a next occurring association period boundary. Additionally or alternatively, the UE 804 may not reset the SSB-RO mapping for the set of additional ROs at the next occurring association period boundary and may continue consecutively mapping the SSBs of the plurality of SSBs 808 or the second plurality of SSBs across the association period boundaries.

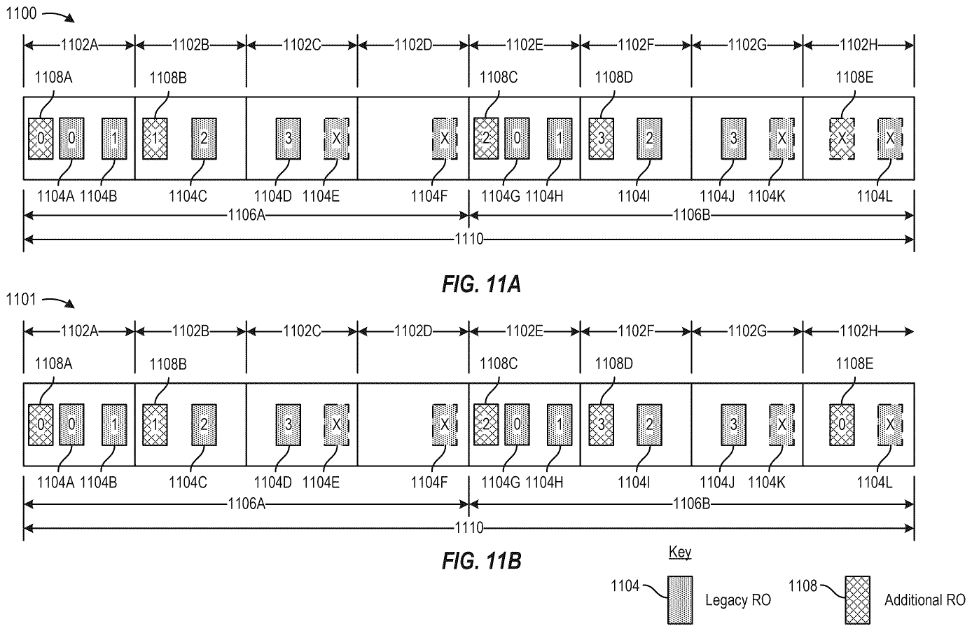

Additionally or alternatively, if the association period(s) are defined and/or are indicated to be maintained for the set of additional ROs, the UE 804 may perform the SSB-RO mapping for the set of additional ROs using the association period(s) defined for the set of additional ROs. For example, the set of additional ROs may include a first set of additional ROs in a third association period and a second set of additional ROs in a fourth association period, where the third association period and the fourth association period are examples of association period(s) defined for the set of additional ROs. Similar to the SSB-RO mapping for the set of legacy ROs, for each of the third association period and the fourth association period, the UE 804 may map the plurality of SSBs or the second plurality of SSBs in the third association period and the fourth association period to the respective sets of additional ROs starting at the first SSB index value or lowest SSB index value (e.g., the SSB-RO mapping for the set of additional ROs resets between the third association period and the fourth association period). This SSB-RO mapping for the set of additional ROs is depicted and described in greater detail with respect to FIGS. 11A and 11B.

In some aspects, a length and/or periodicity of the association period(s) defined for the set of legacy ROs may be different than a length and/or periodicity of the association period(s) defined for the set of additional ROs. For example, a first length of the first association period or the second association period may be different than a second length of the third association period or the fourth association period. Additionally or alternatively, a first periodicity of the first association period or the second association period may be different than a second periodicity of the third association period or the fourth association period.

Subsequently, after receiving the plurality of SSBs 808 (e.g., or the second plurality of SSBs), the first configuration 810, the second configuration 812, and performing one of the SSB-RO mappings for the set of additional ROs described above, the UE 804 may perform a RACH procedure 814 using at least one RO of the set of legacy ROs or the set of additional ROs. For example, the UE 804 may determine the at least one RO based on performing measurements of the plurality of SSBs 808 (e.g., or the second plurality of SSBs) as described above and using one of the SSB-RO mapping options for the set of additional ROs. Additionally, the RACH procedure 814 may include the four-step RACH procedure 500A depicted and described with respect to FIG. 5A and/or the two-step RACH procedure 500B depicted and described with respect to FIG. 5B. For example, the RACH procedure 814 may include one or more messages that are communicated between the UE 804 and the network entity 802 as depicted and described with respect to FIGS. 5A and 5B.

### Example SSB-to-RO Mapping Schemes for Additional ROs

FIGS. 9A and 9B depict example SSB-RO mapping schemes for additional ROs in accordance with aspects of the present disclosure. For example, FIG. 9A depicts a first SSB-RO mapping scheme 900, and FIG. 9B depicts a second SSB-RO mapping scheme 901. In some aspects, the first SSB-RO mapping scheme 900 and the second SSB-RO mapping scheme 901 may implement aspects of or may be implemented by aspects of FIGS. 1-8. For example, a UE may employ the first SSB-RO mapping scheme 900 or the second SSB-RO mapping scheme 901 when mapping one or more SSBs (e.g., received from a network entity) to one or more legacy ROs 904 and one or more additional ROs 908, where the UE can use the one or more legacy ROs 904 and/or the one or more additional ROs 908 for performing a RACH procedure, such as the four-step RACH procedure 500A depicted and described with respect to FIG. 5A and/or the two-step RACH procedure 500B depicted and described with respect to FIG. 5B. In some aspects, the UE may represent the UE 104 depicted and described with respect to FIG. 1, the UE 304 depicted and described with respect to FIG. 3, the UE 504 depicted and described with respect to FIGS. 5A and 5B, or the UE 804 depicted and described with respect to FIG. 8. In some aspects, the network entity may represent an example of the BS 102 depicted and described with respect to FIG. 1, the first network entity 300 or the second network entity 302 depicted and described with respect to FIG. 3, a disaggregated base station depicted and described with respect to FIG. 2, the network entity 502 depicted and described with respect to FIGS. 5A and 5B, or the network entity 802 depicted and described with respect to FIG. 8.

Additionally, the first SSB-RO mapping scheme 900 and the second SSB-RO mapping scheme 901 may represent the SSB-RO mapping for the additional ROs 908 when association period(s) are not defined and/or are indicated to not be maintained for the additional ROs 908 as described with respect to FIG. 8. Subsequently, in the examples of FIGS. 9A and 9B, the UE may perform an SSB-RO mapping for the additional ROs 908 using association period(s) defined for the legacy ROs 904.

In some aspects, the first SSB-RO mapping scheme 900 or the second SSB-RO mapping scheme 901 may include the association period configuration 600 depicted and described with respect to FIG. 6 and/or the association period configurations 700 depicted and described with respect to FIG. 7. For example, the UE may obtain a first PRACH configuration (e.g., the PRACH configuration described with respect to FIG. 6 and/or the first configuration 810 described with respect to FIG. 8) that indicates the one or more legacy ROs 904, such that the first PRACH configuration may be referred to as a legacy PRACH configuration. Additionally, the UE may map SSBs (e.g., a first plurality of SSBs) to the legacy ROs 904 as described and depicted with respect to FIGS. 6 and 7. For example, the UE may determine a first association period 906A that includes a first SSB (e.g., with a first SSB index value, such as ‘0’) mapped to a first legacy RO 904A, a second SSB (e.g., with a second SSB index value, such as ‘1’) mapped to a second legacy RO 904B, a third SSB (e.g., with a third SSB index value, such as ‘2’) mapped to a third legacy RO 904C, and a fourth SSB (e.g., with a fourth SSB index value, such as ‘3’) mapped to a fourth legacy RO 904D, and the first association period 906A may include a first PRACH configuration period 902A, a second PRACH configuration period 902B, a third PRACH configuration period 902C, and a fourth PRACH configuration period 902D. The first association period 906A may also include a fifth legacy RO 904E and a sixth legacy RO 904F that are not mapped to any SSB index, and the UE may not be allowed to use the fifth legacy RO 904E or the sixth legacy RO 904F for the RACH procedure.

Additionally, the UE may determine a second association period 906B that includes the first SSB mapped to a seventh legacy RO 904G, the second SSB mapped to an eighth legacy RO 904H, the third SSB mapped to a ninth legacy RO 904I, and the fourth SSB mapped to a tenth legacy RO 904J, and the second association period 906B may include a fifth PRACH configuration period 902E, a sixth PRACH configuration period 902F, a seventh PRACH configuration period 902G, and an eighth PRACH configuration period 902H. The second association period 906B may also include an eleventh legacy RO 904K and a twelfth legacy RO 904L that are not mapped to any SSB index, and the UE may not be allowed to use the eleventh legacy RO 904K or the twelfth legacy RO 904L for the RACH procedure.

Additionally, the UE may obtain a second PRACH configuration (e.g., the second PRACH configuration described with respect to FIG. 7 and/or the second configuration 812 described with respect to FIG. 8) that indicates the one or more additional ROs 908. In the example of FIG. 9A, if no separate association period(s) are defined for the additional ROs 908, the UE may perform the SSB-RO mapping consecutively for the additional ROs 908 in a similar manner to the SSB-RO mapping for the legacy ROs 904 described above, such that the SSB-RO mapping for the additional ROs 908 resets on the boundary of the association period(s) defined for the legacy ROs 904 (e.g., the first association period 906A and the second association period 906B). In some aspects, the UE may reset the SSB-RO mapping for the additional ROs 908 on the boundary of the association period(s) defined for the legacy ROs 904 regardless of whether all SSBs are already mapped or not to the additional ROs 908.

For example, for the first association period 906A, the UE may map a first SSB configured with an SSB index value of ‘0’ (e.g., the first SSB described above for the legacy ROs 904 or a first SSB of a second plurality of SSBs) to a first additional RO 908A in the first PRACH configuration period 902A and a second SSB configured with an SSB index value of ‘1’ (e.g., the second SSB described above for the legacy ROs 904 or a second SSB of a second plurality of SSBs) to a second additional RO 908B in the second PRACH configuration period 902B. Additionally, while the first SSB is configured with the SSB index value of ‘0’ in the example of FIG. 9A, the first SSB may be configured with any first SSB index value (e.g., other than ‘0’) or offset from an SSB index value for a first sent SSB.

Subsequently, even though not all of the SSBs have been mapped at least once to a respective additional RO 908 in the first association period 906A, the UE may then reset the SSB-RO mapping for the additional ROs 908 at the boundary between the first association period 906A and the second association period 906B. For example, for the second association period 906A, the UE may map the first SSB configured with the SSB index value of ‘0’ to a third additional RO 908C in the fifth PRACH configuration period 902E, the second SSB configured with the SSB index value of ‘1’ to a fourth additional RO 908D in the sixth PRACH configuration period 902F, and a third SSB configured with an index value of ‘2’ (e.g., the third SSB described above for the legacy ROs 904 or a third SSB of a second plurality of SSBs) to a fifth additional RO 908E in the eighth PRACH configuration period 902H.

That is, in the example of FIG. 9A, the UE may map a first subset of SSBs of a plurality of SSBs or a second plurality of SSBs to a first set of additional ROs in the first association period 906A and/or a second subset of SSBs of the plurality of SSBs or the second plurality of SSBs to a second set of additional ROs in the second association period 906B. Additionally or alternatively, although not shown in the example of FIG. 9A, the UE may map all SSBs of the plurality of SSBs or the second plurality of SSBs to the first set of additional ROs in the first association period 906A and/or to the second set of additional ROs in the second association period 906B. Additionally or alternatively, the UE may map the first subset of SSBs in the first association period 906A and may map all SSBs in the second association period 906B, or the UE may map all SSBs in the first association period 906A and may map the second subset of SSBs in the second association period 906B.

Additionally or alternatively, in the example of FIG. 9B, the UE may perform the SSB-RO mapping consecutively for the additional ROs 908 similar to the legacy ROs 904, but the UE may reset the SSB-RO mapping for the additional ROs 908 at a boundary of the association period(s) defined for the legacy ROs 904 if all SSBs have already been mapped at least once. For example, the UE may map the first SSB configured with the SSB index value of ‘0’ to the first additional RO 908A in the first PRACH configuration period 902A, the second SSB configured with the SSB index value of ‘1’ to the second additional RO 908B in the second PRACH configuration period 902B, the third SSB configured with the SSB index value of ‘2’ to the third additional RO 908C in the fifth PRACH configuration period 902E, and a fourth SSB configured with an index value of ‘3’ (e.g., the fourth SSB described above for the legacy ROs 904 or a fourth SSB of a second plurality of SSBs) to the fourth additional RO 908D in the sixth PRACH configuration period 902F.

As such, the UE may perform the SSB-RO mapping for the additional ROs 908 collectively across the first association period 906A and the second association period 906B to map all the SSBs to respective additional ROs 908, where the second association period 906B may correspond to the at least the third association period described with respect to FIG. 8. While two association periods are shown in the example of FIG. 9B for the SSB-RO mapping for the additional ROs 908, more than two association periods may be used for the SSB-RO mapping for the additional ROs 908 to map all the SSBs to respective additional ROs 908.

In some aspects, if after mapping all SSBs to the additional ROs 908 there are still one or more additional ROs 908 that do not map to all of the SSBs, the UE may either keep the one or more additional ROs 908 mapped to an SSB or may not map the one or more additional ROs 908 to any SSB. For example, a fifth additional RO 908E may be configured in the eighth PRACH configuration period 902H of the second association period 906B, but all SSBs may have already been mapped at least once collectively across the first association period 906A and the second association period 906B. Accordingly, in some aspects, the UE may map the first SSB configured with the SSB index value of ‘O’ to the fifth additional RO 908E. That is, the UE may map at least one SSB (e.g., of the plurality of SSBs or the second plurality of SSBs) to multiple additional ROs 908. Additionally or alternatively, although not shown in the example of FIG. 9B, the UE may not map any SSB to the fifth additional RO 908E, and the UE may not be allowed to use the fifth additional RO 908E for performing the RACH procedure.

Subsequently, in the example of FIG. 9B, after all SSBs have been mapped at least once, the UE may reset the SSB-RO mapping for the additional ROs 908 after a boundary of the second association period 906B. For example, the UE may map the first SSB configured with the SSB index value of ‘0’ to a sixth additional RO 908F in a ninth PRACH configuration period 902I of a third association period 906C based on all SSBs being mapped to respective additional ROs 908 collectively across the first association period 906A and the second association period 906B. Accordingly, although not shown, the UE may continue the consecutive mapping of the SSBs to respective additional ROs 908 in the third association period 906C and, optionally, one or more additional association periods after the third association period 906C until all SSBs are mapped at least once.

FIGS. 10A and 10B depict example SSB-RO mapping schemes for additional ROs in accordance with aspects of the present disclosure. For example, FIG. 10A depicts a first SSB-RO mapping scheme 1000, and FIG. 10B depicts a second SSB-RO mapping scheme 1001. In some aspects, the first SSB-RO mapping scheme 1000 and the second SSB-RO mapping scheme 1001 may implement aspects of or may be implemented by aspects of FIGS. 1-8. For example, a UE may employ the first SSB-RO mapping scheme 1000 or the second SSB-RO mapping scheme 1001 when mapping one or more SSBs (e.g., received from a network entity) to one or more legacy ROs 1004 and one or more additional ROs 1008, where the UE can use the one or more legacy ROs 1004 and/or the one or more additional ROs 1008 for performing a RACH procedure, such as the four-step RACH procedure 500A depicted and described with respect to FIG. 5A and/or the two-step RACH procedure 500B depicted and described with respect to FIG. 5B. In some aspects, the UE may represent the UE 104 depicted and described with respect to FIG. 1, the UE 304 depicted and described with respect to FIG. 3, the UE 504 depicted and described with respect to FIGS. 5A and 5B, or the UE 804 depicted and described with respect to FIG. 8. In some aspects, the network entity may represent an example of the BS 102 depicted and described with respect to FIG. 1, the first network entity 300 or the second network entity 302 depicted and described with respect to FIG. 3, a disaggregated base station depicted and described with respect to FIG. 2, the network entity 502 depicted and described with respect to FIGS. 5A and 5B, or the network entity 802 depicted and described with respect to FIG. 8.

Additionally, the first SSB-RO mapping scheme 1000 and the second SSB-RO mapping scheme 1001 may represent the SSB-RO mapping for the additional ROs 1008 when association period(s) are not defined and/or are not indicated to be maintained for the additional ROs 1008 as described with respect to FIG. 8. Subsequently, in the examples of FIGS. 10A and 10B, the UE may perform an SSB-RO mapping for the additional ROs 1008 irrespective of association period(s) defined for the legacy ROs 1004. That is, the UE may not reset the SSB-RO mapping for the additional ROs 1008 based on boundaries of the association period(s) defined for the legacy ROs 1004.

In some aspects, the first SSB-RO mapping scheme 1000 or the second SSB-RO mapping scheme 1001 may include the association period configuration 600 depicted and described with respect to FIG. 6 and/or the association period configurations 700 depicted and described with respect to FIG. 7. For example, the UE may obtain a first PRACH configuration (e.g., the PRACH configuration described with respect to FIG. 6 and/or the first configuration 810 described with respect to FIG. 8) that indicates the one or more legacy ROs 1004, such that the first PRACH configuration may be referred to as a legacy PRACH configuration. Additionally, the UE may map SSBs (e.g., a first plurality of SSBs) to the legacy ROs 1004 as described and depicted with respect to FIGS. 6 and 7. For example, the UE may determine a first association period 1006A that includes a first SSB (e.g., with a first SSB index value, such as ‘0’) mapped to a first legacy RO 1004A, a second SSB (e.g., with a second SSB index value, such as ‘1’) mapped to a second legacy RO 1004B, a third SSB (e.g., with a third SSB index value, such as ‘2’) mapped to a third legacy RO 1004C, and a fourth SSB (e.g., with a fourth SSB index value, such as ‘3’) mapped to a fourth legacy RO 1004D, and the first association period 1006A may include a first PRACH configuration period 1002A, a second PRACH configuration period 1002B, a third PRACH configuration period 1002C, and a fourth PRACH configuration period 1002D. The first association period 1006A may also include a fifth legacy RO 1004E and a sixth legacy RO 1004F that are not mapped to any SSB index, and the UE may not be allowed to use the fifth legacy RO 1004E or the sixth legacy RO 1004F for the RACH procedure.

Additionally, the UE may determine a second association period 1006B that includes the first SSB mapped to a seventh legacy RO 1004G, the second SSB mapped to an eighth legacy RO 1004H, the third SSB mapped to a ninth legacy RO 1004I, and the fourth SSB mapped to a tenth legacy RO 1004J, and the second association period 1006B may include a fifth PRACH configuration period 1002E, a sixth PRACH configuration period 1002F, a seventh PRACH configuration period 1002G, and an eighth PRACH configuration period 1002H. The second association period 1006B may also include an eleventh legacy RO 1004K and a twelfth legacy RO 1004L that are not mapped to any SSB index, and the UE may not be allowed to use the eleventh legacy RO 1004K or the twelfth legacy RO 1004L for the RACH procedure.

Additionally, the UE may obtain a second PRACH configuration (e.g., the second PRACH configuration described with respect to FIG. 7 and/or the second configuration 812 described with respect to FIG. 8) that indicates the one or more additional ROs 1008. Accordingly, in the examples of FIGS. 10A and 10B, the UE may then perform an SSB-RO mapping for the additional ROs 1008 irrespective of association period(s) defined for the legacy ROs 1004 (e.g., the first association period 1006A and the second association period 1006B). For example, the UE may map a first SSB configured with the SSB index value of ‘0’ (e.g., the first SSB described above for the legacy ROs 1004 or a first SSB of a second plurality of SSBs) to a first additional RO 1008A in the first PRACH configuration period 1002A, a second SSB configured with the SSB index value of ‘1’ (e.g., the second SSB described above for the legacy ROs 1004 or a first SSB of a second plurality of SSBs) to a second additional RO 1008B in the second PRACH configuration period 1002B, a third SSB configured with the SSB index value of ‘2’ (e.g., the third SSB described above for the legacy ROs 1004 or a third SSB of a second plurality of SSBs) to a third additional RO 1008C in the fifth PRACH configuration period 1002E, and a fourth SSB configured with an index value of ‘3’ (e.g., the fourth SSB described above for the legacy ROs 1004 or a fourth SSB of a second plurality of SSBs) to a fourth additional RO 1008D in the sixth PRACH configuration period 1002F. In some aspects, the first SSB may be configured with any first SSB index value (e.g., other than ‘0’) or offset from an SSB index value for a first sent SSB.

In some aspects, after mapping all SSBs at least once to a respective additional RO 1008, there may exist one or more additional ROs 1008 that can be mapped to a subset of the SSBs. That is, as described with reference to FIG. 8, at least one additional RO of the plurality of additional ROs may occur after the set of additional ROs. For example, a fifth additional RO 1008E may be configured in the eighth PRACH configuration period 1002H, and the fifth additional RO 1008E may exist after all the SSBs have been mapped at least once to respective additional ROs 1008. In the example of FIG. 10A, the UE may not map any SSB to the fifth additional RO 1008E and may consider the fifth additional RO 1008E unavailable for performing the RACH procedure. This option may ensure that there is a uniform distribution of SSBs across the additional ROs 1008. Additionally or alternatively, in the example of FIG. 10B, the UE may map the first SSB configured with the SSB index value of ‘0’ to the fifth additional RO 1008E and may consider the fifth additional RO 1008E available for performing the RACH procedure (e.g., the fifth additional RO 1008E is valid). That is, as described with reference to FIG. 8, at least one SSB of the plurality of SSBs or the second plurality of SSBs may be mapped to multiple ROs of the plurality of additional ROs, and at least one RO of the multiple ROs may occur after the set of additional ROs.

In some aspects, after all SSBs are mapped at least once across and irrespective of one or more association period(s) defined for the legacy ROs 1004, the UE may not reset the SSB-RO mapping for the additional ROs 1008 at the next occurring association period boundary and may continue consecutively mapping the SSBs across the association period boundaries. Subsequently, across a total duration for an association pattern period (e.g., a repetition period of 16 frames and/or 160 ms that includes one or more association periods), each SSB of the plurality of SSBs or the second plurality of SSBs may be mapped to at least a minimum same quantity of additional ROs 1008. However, a quantity of remaining additional ROs 1008 may be configured in the association pattern period after each SSB has been mapped to at least the minimum same quantity of additional ROs 1008, and the quantity of remaining additional ROs 1008 may be less than the total quantity of SSBs (e.g., a subset of the total quantity of SSBs can be mapped to the remaining additional ROs 1008). Accordingly, the UE may or may not map SSBs to the remaining additional ROs as described above.

FIGS. 11A and 11B depict example SSB-RO mapping schemes for additional ROs in accordance with aspects of the present disclosure. For example, FIG. 11A depicts a first SSB-RO mapping scheme 1100, and FIG. 11B depicts a second SSB-RO mapping scheme 1101. In some aspects, the first SSB-RO mapping scheme 1100 and the second SSB-RO mapping scheme 1101 may implement aspects of or may be implemented by aspects of FIGS. 1-8. For example, a UE may employ the first SSB-RO mapping scheme 1100 or the second SSB-RO mapping scheme 1101 when mapping one or more SSBs (e.g., received from a network entity) to one or more legacy ROs 1104 and one or more additional ROs 1108, where the UE can use the one or more legacy ROs 1104 and/or the one or more additional ROs 1108 for performing a RACH procedure, such as the four-step RACH procedure 500A depicted and described with respect to FIG. 5A and/or the two-step RACH procedure 500B depicted and described with respect to FIG. 5B. In some aspects, the UE may represent the UE 104 depicted and described with respect to FIG. 1, the UE 304 depicted and described with respect to FIG. 3, the UE 504 depicted and described with respect to FIGS. 5A and 5B, or the UE 804 depicted and described with respect to FIG. 8. In some aspects, the network entity may represent an example of the BS 102 depicted and described with respect to FIG. 1, the first network entity 300 or the second network entity 302 depicted and described with respect to FIG. 3, a disaggregated base station depicted and described with respect to FIG. 2, the network entity 502 depicted and described with respect to FIGS. 5A and 5B, or the network entity 802 depicted and described with respect to FIG. 8.

Additionally, the first SSB-RO mapping scheme 1100 and the second SSB-RO mapping scheme 1101 may represent the SSB-RO mapping for the additional ROs 1108 when association period(s) are defined and are indicated to be maintained for the additional ROs 1108 as described with respect to FIG. 8. Subsequently, in the examples of FIGS. 11A and 11B, the UE may perform an SSB-RO mapping for the additional ROs 1108 based on association period(s) defined for the additional ROs 1108.

In some aspects, the first SSB-RO mapping scheme 1100 or the second SSB-RO mapping scheme 1101 may include the association period configuration 600 depicted and described with respect to FIG. 6 and/or the association period configurations 700 depicted and described with respect to FIG. 7. For example, the UE may obtain a first PRACH configuration (e.g., the PRACH configuration described with respect to FIG. 6 and/or the first configuration 810 described with respect to FIG. 8) that indicates the one or more legacy ROs 1104, such that the first PRACH configuration may be referred to as a legacy PRACH configuration. Additionally, the UE may map SSBs (e.g., a first plurality of SSBs) to the legacy ROs 1104 as described and depicted with respect to FIGS. 6 and 7. For example, the UE may determine a first association period 1106A that includes a first SSB (e.g., with a first SSB index value, such as ‘0’) mapped to a first legacy RO 1104A, a second SSB (e.g., with a second SSB index value, such as ‘1’) mapped to a second legacy RO 1104B, a third SSB (e.g., with a third SSB index value, such as ‘2’) mapped to a third legacy RO 1104C, and a fourth SSB (e.g., with a fourth SSB index value, such as ‘3’) mapped to a fourth legacy RO 1104D, and the first association period 1106A may include a first PRACH configuration period 1102A, a second PRACH configuration period 1102B, a third PRACH configuration period 1102C, and a fourth PRACH configuration period 1102D. The first association period 1106A may also include a fifth legacy RO 1104E and a sixth legacy RO 1104F that are not mapped to any SSB index, and the UE may not be allowed to use the fifth legacy RO 1104E or the sixth legacy RO 1104F for the RACH procedure.

Additionally, the UE may determine a second association period 1106B that includes the first SSB mapped to a seventh legacy RO 1104G, the second SSB mapped to an eighth legacy RO 1104H, the third SSB mapped to a ninth legacy RO 1104I, and the fourth SSB mapped to a tenth legacy RO 1104J, and the second association period 1106B may include a fifth PRACH configuration period 1102E, a sixth PRACH configuration period 1102F, a seventh PRACH configuration period 1102G, and an eighth PRACH configuration period 1102H. The second association period 1106B may also include an eleventh legacy RO 1104K and a twelfth legacy RO 1104L that are not mapped to any SSB index, and the UE may not be allowed to use the eleventh legacy RO 1104K or the twelfth legacy RO 1104L for the RACH procedure.

Additionally, the UE may obtain a second PRACH configuration (e.g., the second PRACH configuration described with respect to FIG. 7 and/or the second configuration 812 described with respect to FIG. 8) that indicates the one or more additional ROs 1108. In the examples of FIGS. 11A and 11B, if separate association period(s) are defined for the additional ROs 1108, the UE may perform the SSB-RO mapping consecutively for the additional ROs 1108 using the association period(s) defined for the additional ROs 1108, such that the SSB-RO mapping for the additional ROs 1108 resets on the boundary of the association period(s) defined for the additional ROs 1108. For example, the network may indicate to the UE that the separate association period(s) should be maintained for the additional ROs 1108 as described with respect to FIG. 8, where the indication is sent via the second PRACH configuration, semi-static signaling, a SIB (e.g., SIB1), and/or RRC signaling.

Accordingly, in the examples of FIGS. 11A and 11B, the UE may determine a third association period 1110 for mapping SSBs to the additional ROs 1108, where the third association period 1110 is defined for the additional ROs 1108. For example, in the third association period 1110, the UE may map a first SSB configured with the SSB index value of ‘0’ (e.g., the first SSB described above for the legacy ROs 1104 or a first SSB of a second plurality of SSBs) to a first additional RO 1108A in the first PRACH configuration period 1102A, a second SSB configured with the SSB index value of ‘1’ (e.g., the second SSB described above for the legacy ROs 1104 or a first SSB of a second plurality of SSBs) to a second additional RO 1108B in the second PRACH configuration period 1102B, a third SSB configured with the SSB index value of ‘2’ (e.g., the third SSB described above for the legacy ROs 1104 or a third SSB of a second plurality of SSBs) to a third additional RO 1108C in the fifth PRACH configuration period 1102E, and a fourth SSB configured with an index value of ‘3’ (e.g., the fourth SSB described above for the legacy ROs 1104 or a fourth SSB of a second plurality of SSBs) to a fourth additional RO 1108D in the sixth PRACH configuration period 1102F. Subsequently, although not shown in the examples of FIGS. 11A and 11B, the UE may then reset the SSB-RO mapping for the additional ROs 1108 at a boundary of the association period(s) defined for the additional ROs 1108 (e.g., for an association period defined for the additional ROs 1108 after the third association period 1110, such as a fourth association period). In some aspects, the first SSB may be configured with any first SSB index value (e.g., other than ‘0’) or offset from an SSB index value for a first sent SSB.

In some aspects, after mapping all SSBs at least once to a respective additional RO 1108 in the third association period 1110, there may exist one or more additional ROs 1108 that can be mapped to a subset of the SSBs. That is, as described with reference to FIG. 8, at least one additional RO of the plurality of additional ROs may occur after the first set of additional ROs in the third association period, after the second set of additional ROs in the fourth association period, or both. For example, a fifth additional RO 1108E may be configured in the eighth PRACH configuration period 1002H, and the fifth additional RO 1008E may exist after all the SSBs have been mapped at least once to respective additional ROs 1108. In the example of FIG. 11A, the UE may not map any SSB to the fifth additional RO 1108E and may consider the fifth additional RO 1108E unavailable for performing the RACH procedure. This option may ensure that there is a uniform distribution of SSBs across the additional ROs 1108 in the association period(s) defined for the additional ROs 1108.

Additionally or alternatively, in the example of FIG. 11B, the UE may map the first SSB configured with the SSB index value of ‘0’ to the fifth additional RO 1108E and may consider the fifth additional RO 1108E available for performing the RACH procedure (e.g., the fifth additional RO 1108E is valid). That is, as described with reference to FIG. 8, at least one SSB of the plurality of SSBs or the second plurality of SSBs may be mapped to multiple ROs in the third association period, in the fourth association period, or both, and at least one RO of the multiple ROs may occur after the first set of additional ROs, after the second set of additional ROs, or both. This option may assist in activating more additional ROs 1108 for the RACH procedure that could be potentially useful if dynamically activated.

### Example Signaling for SSB-to-RO Mapping Schemes for Additional ROS

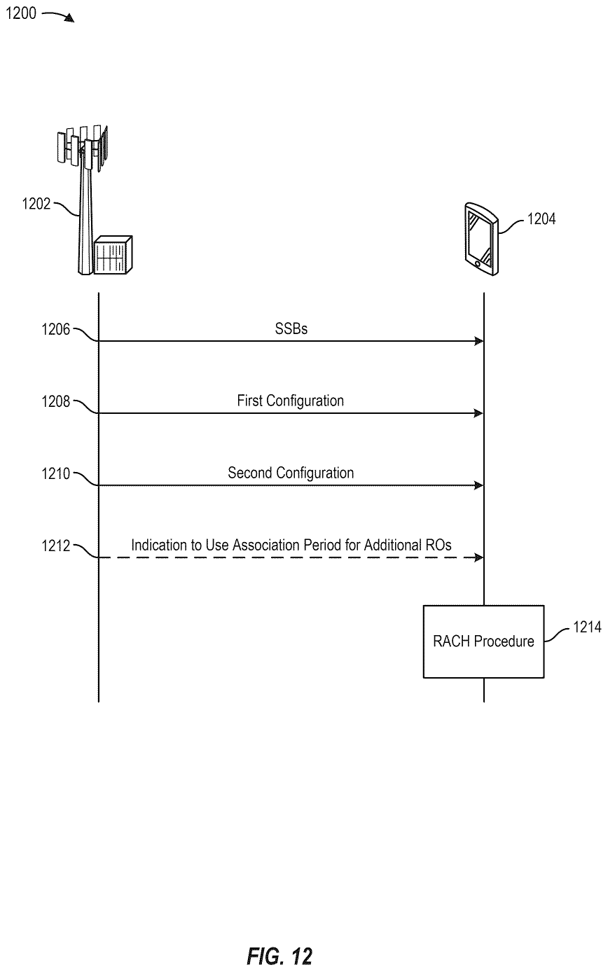

FIG. 12 depicts a process flow 1200 for communications in a network between a network entity 1202 and a UE 1204. In some aspects, the network entity 1202 may be an example of the BS 102 depicted and described with respect to FIG. 1, the first network entity 300 or the second network entity 302 depicted and described with respect to FIG. 3, a disaggregated base station depicted and described with respect to FIG. 2, or the network entity 802 depicted and described with respect to FIG. 8. Similarly, the UE 1204 may be an example of the UE 104 depicted and described with respect to FIG. 1, the UE 304 depicted and described with respect to FIG. 3, or the UE 804 depicted and described with respect to FIG. 8. However, in other aspects, UE 1204 may be another type of wireless communications device and network entity 1202 may be another type of network entity or network node, such as those described herein. Note that any operations or signaling illustrated with dashed lines may indicate that that operation or signaling is an optional or alternative example.

At 1206, the UE 1204 obtains a plurality of SSBs (e.g., the plurality of SSBs 808 and/or a second plurality of SSBs described with respect to FIG. 8). For example, the network entity 1202 may send the plurality of SSBs in a broadcast manner. Additionally, the network entity 1202 may send each SSB of the plurality of SSBs via a respective beam (e.g., beamformed transmission).

At 1208, the network entity 1202 sends and the UE 1204 obtains a first configuration that indicates a plurality of legacy ROs (e.g., the first configuration 810 described with respect to FIG. 8). In some aspects, the plurality of SSBs may be mapped to a set of legacy ROs of the plurality of legacy ROs (e.g., as described with respect to FIGS. 6-7 and 9A-11B). For example, the set of legacy ROs may include a first set of legacy ROs in a first association period and a second set of legacy ROs in a second association period. Additionally, for each of the first association period and the second association period, the plurality of SSBs may be mapped starting at a first SSB index value or a lowest SSB index value. In some aspects, a first SSB of the plurality of SSBs may be configured with any first SSB index value (e.g., other than ‘0’) or offset from an SSB index value for a first sent SSB.

At 1210, the network entity 1202 sends and the UE 1204 obtains a second configuration that indicates a plurality of additional ROs (e.g., the second configuration 812 described with respect to FIG. 8). In some aspects, the one or more SSBs of the plurality of SSBs or a second plurality of SSBs may be mapped to a set of additional ROs of the plurality of additional ROs (e.g., as described with respect to FIGS. 7 and 9A-11B). For example, as described with respect to FIGS. 9A and 9B, the set of additional ROs may include a first set of additional ROs in the first association period and a second set of additional ROs in the second association period. Additionally, for each of the first association period and the second association period, the one or more SSBs of the plurality of SSBs or the second plurality of SSBs may be mapped starting at the first SSB index value or the lowest SSB index value.

In some aspects, as depicted and described with respect to FIG. 9A, the first association period and second association period may be adjacent in time. Additionally or alternatively, as depicted and described with respect to FIG. 9B, the first association period and the second association period may be separated in time by at least a third association period. For example, all SSBs of the plurality of SSBs or the second plurality of SSBs may not be mapped to the first set of additional ROs in the first association period, and all SSBs of the plurality of SSBs or the second plurality of SSBs may be mapped collectively to the first set of additional ROs in the first association period and to a third set of additional ROs in the at least the third association period. Subsequently, the one or more SSBs of the plurality of SSBs or the second plurality of SSBs may be mapped starting at the first SSB index value or the lowest SSB index value in the second association period based on all SSBs of the plurality of SSBs or the second plurality of SSBs being mapped collectively to the first set of additional ROs in the first association period and to the third set of additional ROs in the at least the third association period. In some aspects, as depicted and described with respect to FIG. 9B, at least one SSB of the plurality of SSBs or the second plurality of SSBs may be mapped to multiple ROs of the first set of additional ROs and the third set of additional ROs and/or one or more additional ROs of the first set of additional ROs and the third set of additional ROs may be considered unavailable for RACH procedures.

In some aspects, a first subset of the plurality of SSBs or the second plurality of SSBs may be mapped to the first set of additional ROs in the first association period, a second subset of the plurality of SSBs or the second plurality of SSBs may be mapped to the second set of additional ROs in the second association period, all SSBs of the plurality of SSBs or the second plurality of SSBs may be mapped to the first set of additional ROs in the first association period, all SSBs of the plurality of SSBs or the second plurality of SSBs may be mapped to the second set of additional ROs in the second association period, or a combination thereof.

Additionally or alternatively, as depicted and described with respect to FIGS. 10A and 10B, the plurality of SSBs or the second plurality of SSBs may be mapped to a set of additional ROs of the plurality of additional ROs irrespective of the first association period and the second association period. In some aspects, as described with respect to FIG. 10A, at least one additional RO of the plurality of additional ROs may occur after the set of additional ROs, and the at least one additional RO may not be available for the RACH procedures. Additionally or alternatively, as described with respect to FIG. 10B, at least one SSB of the plurality of SSBs or the second plurality of SSBs may be mapped to multiple ROs of the plurality of additional ROs, and at least one RO of the multiple ROs may occur after the set of additional ROs. Accordingly, the multiple ROs of the plurality of additional ROs may be available for the RACH procedures.

Additionally or alternatively, as depicted and described with respect to FIGS. 11A and 11B, one or more SSBs of the plurality of SSBs or the second plurality of SSBs may be mapped to a set of additional ROs of the plurality of additional ROs, where the set of additional ROs includes a first set of additional ROs in a third association period and a second set of additional ROs in a fourth association period. Additionally, for each of the third association period and the fourth association period, the plurality of SSBs or the second plurality of SSBs may be mapped starting at the first SSB index value or the lowest SSB index value.

In some aspects, as depicted and described with respect to FIG. 11A, at least one additional RO of the plurality of additional ROs may occur after the first set of additional ROs in the third association period, after the second set of additional ROs in the fourth association period, or both, and the at least one additional RO may not be available for the RACH procedure. Additionally or alternatively, as depicted and described with respect to FIG. 11B, at least one SSB of the plurality of SSBs or the second plurality of SSBs may be mapped to multiple ROs in the third association period, in the fourth association period, or both, and at least one RO of the multiple ROs may occur after the first set of additional ROs, after the second set of additional ROs, or both. Accordingly, the multiple ROs of the plurality of additional ROs may be available for the RACH procedures

In some aspects, a first length of the first association period or the second association period is different than a second length of the third association period or the fourth association period. Additionally or alternatively, a first periodicity of the first association period or the second association period is different than a second periodicity of the third association period or the fourth association period.

At 1212, the network entity 1202 may send and the UE 1204 may obtain an indication that the third association period and the fourth association period are to be used for mapping the one or more SSBs to the set of additional ROs. In some aspects, the network entity 1202 may send and the UE 1204 may obtain the indication via at least one of: the second configuration, semi-static signaling, a SIB (e.g., SIB1), or RRC signaling.

At 1214, the UE 1204 performs a RACH procedure (e.g., the RACH procedure 814 described with respect to FIG. 8) using at least one RO of the set of legacy ROs or the set of additional ROs. For example, the RACH procedure may include the four-step RACH procedure 500A depicted and described with respect to FIG. 5A and/or the two-step RACH procedure 500B depicted and described with respect to FIG. 5B.

Accordingly, for the RACH procedure, the UE 1204 and the network entity 1202 may exchange one or more messages as depicted and described with respect to FIGS. 5A and 5B. Additionally, the UE may determine the at least one RO based on the plurality of SSBs, such as based on performing measurements of each SSB of the plurality of SSBs.

Note that the process flow 1200 illustrated in FIG. 12 is an example of a RACH procedure, and aspects of the present disclosure may be applied to performing a RACH procedure based on an SSB-to-RO mapping scheme for additional ROs. Note that the process flow illustrated in FIG. 12 is described herein to facilitate an understanding of performing a RACH procedure based on an SSB-to-RO mapping scheme for additional ROs, and aspects of the present disclosure may be performed in various manners via alternative or additional signaling and/or operations. In certain aspects, the operations and/or signaling of FIG. 12 may occur in an order different from that described or depicted, and various actions, operations, and/or signaling may be added, omitted, or combined.

### Example Operations of a User Equipment

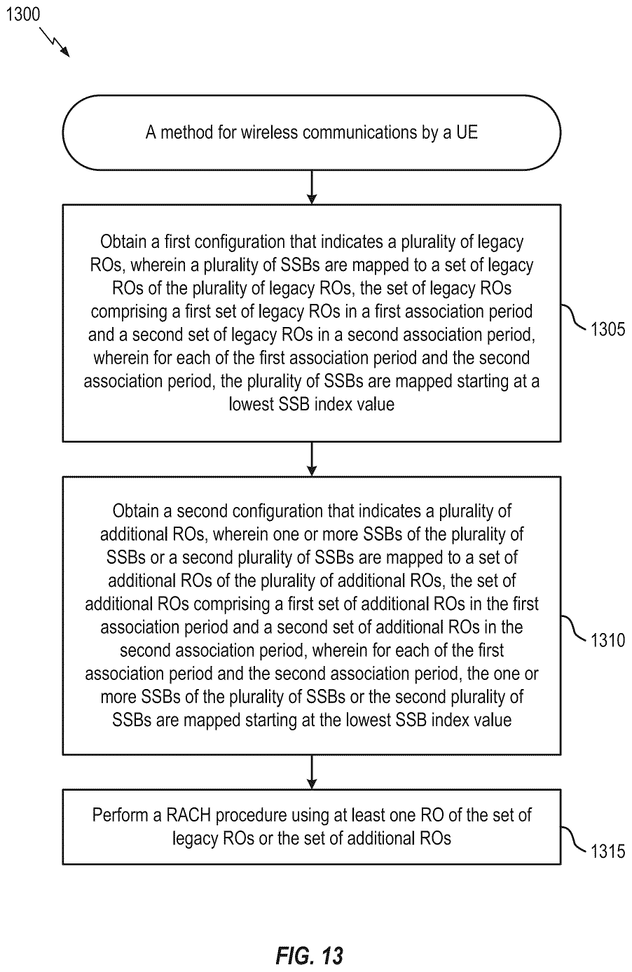

FIG. 13 shows a method 1300 for wireless communications by an apparatus, such as UE 104 of FIG. 1 or UE 304 of FIG. 3.

Method 1300 begins at block 1305 with obtaining a first configuration that indicates a plurality of legacy ROs (e.g., the first configuration 810 described with respect to FIG. 8), wherein a plurality of SSBs are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value.

Method 1300 then proceeds to block 1310 with obtaining a second configuration that indicates a plurality of additional ROs (e.g., the second configuration 812 described with respect to FIG. 8), wherein one or more SSBs of the plurality of SSBs or a second plurality of SSBs are mapped to a set of additional ROs of the plurality of additional ROs, the set of additional ROs comprising a first set of additional ROs in the first association period and a second set of additional ROs in the second association period, wherein for each of the first association period and the second association period, the one or more SSBs of the plurality of SSBs or the second plurality of SSBs are mapped starting at the lowest SSB index value (e.g., as depicted and described with respect to FIGS. 9A and 9B).

Method 1300 then proceeds to block 1315 with performing a RACH procedure (e.g., the RACH procedure 814 described with respect to FIG. 8, the four-step RACH procedure 500A depicted and described with respect to FIG. 5A, and/or the two-step RACH procedure 500B depicted and described with respect to FIG. 5B) using at least one RO of the set of legacy ROs or the set of additional ROs.

In some aspects, the first association period and second association period are adjacent in time.

In some aspects, the first association period and the second association period are separated in time by at least a third association period.

In some aspects, all SSBs of the plurality of SSBs or the second plurality of SSBs are not mapped to the first set of additional ROs in the first association period, and all SSBs of the plurality of SSBs or the second plurality of SSBs are mapped collectively to the first set of additional ROs in the first association period and to a third set of additional ROs in the at least the third association period.

In some aspects, the one or more SSBs of the plurality of SSBs or the second plurality of SSBs are mapped starting at the lowest SSB index value in the second association period based at least in part on all SSBs of the plurality of SSBs or the second plurality of SSBs being mapped collectively to the first set of additional ROs in the first association period and to the third set of additional ROs in the at least the third association period.

In some aspects, at least one SSB of the plurality of SSBs or the second plurality of SSBs is mapped to multiple ROs of the first set of additional ROs and the third set of additional ROs.

In some aspects, a first subset of the plurality of SSBs or the second plurality of SSBs are mapped to the first set of additional ROs in the first association period, a second subset of the plurality of SSBs or the second plurality of SSBs are mapped to the second set of additional ROs in the second association period, all SSBs of the plurality of SSBs or the second plurality of SSBs are mapped to the first set of additional ROs in the first association period, all SSBs of the plurality of SSBs or the second plurality of SSBs are mapped to the second set of additional ROs in the second association period, or a combination thereof.

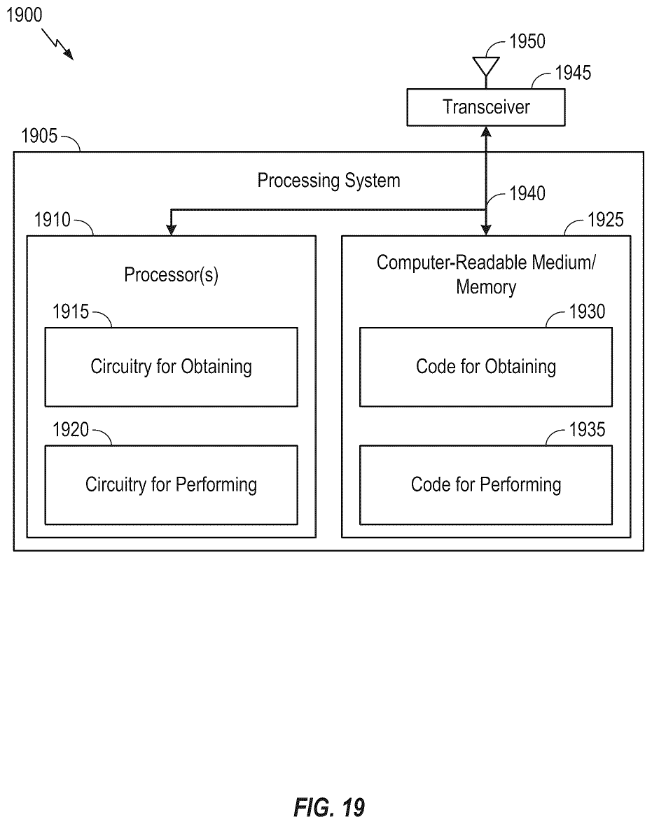

In some aspect, method 1300, or any aspect related to it, may be performed by an apparatus, such as communications device 1900 of FIG. 19, which includes various components operable, configured, or adapted to perform the method 1300. Communications device 1900 is described below in further detail.

Note that FIG. 13 is just one example of a method, and other methods including fewer, additional, or alternative operations are possible consistent with this disclosure.

In certain aspects, method 1300 may be performed by the apparatus to realize one or more technical effects or solutions to the aforementioned technical problem(s). For example, based on method 1300, an SSB-RO mapping for additional ROs may define how SSBs are mapped to the additional ROs to enable the apparatus to determine which additional RO to potentially use for a RACH procedure based on a received SSB. Subsequently, a higher quantity of ROs may be made available to the apparatus via the additional ROs to perform the RACH procedure, which may increase reliability for communications. For example, increasing the quantity of available ROs may increase a likelihood that the apparatus can successfully perform respective RACH procedures.

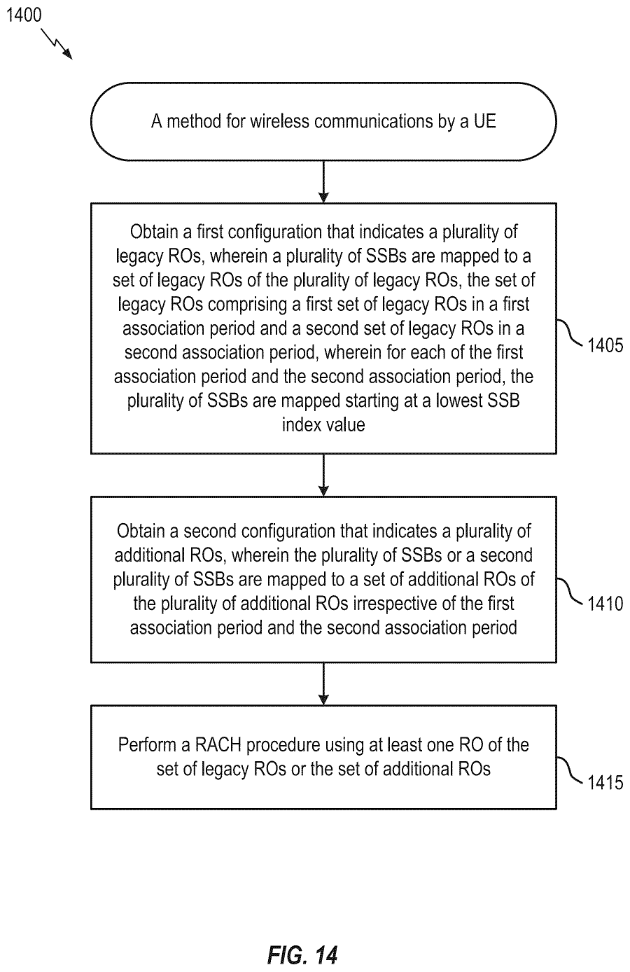

FIG. 14 shows a method 1400 for wireless communications by an apparatus, such as UE 104 of FIG. 1 or UE 304 of FIG. 3.

Method 1400 begins at block 1405 with obtaining a first configuration that indicates a plurality of legacy ROs (e.g., the first configuration 810 described with respect to FIG. 8), wherein a plurality of SSBs are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value.

Method 1400 then proceeds to block 1410 with obtaining a second configuration that indicates a plurality of additional ROs (e.g., the second configuration 812 described with respect to FIG. 8), wherein the plurality of SSBs or a second plurality of SSBs are mapped to a set of additional ROs of the plurality of additional ROs irrespective of the first association period and the second association period (e.g., as depicted and described with respect to FIGS. 10A and 10B).

Method 1400 then proceeds to block 1415 with performing a RACH procedure (e.g., the RACH procedure 814 described with respect to FIG. 8, the four-step RACH procedure 500A depicted and described with respect to FIG. 5A, and/or the two-step RACH procedure 500B depicted and described with respect to FIG. 5B) using at least one RO of the set of legacy ROs or the set of additional ROs.

In some aspects, at least one additional RO of the plurality of additional ROs occurs after the set of additional ROs, and the at least one additional RO is not available for the RACH procedure.

In some aspects, at least one SSB of the plurality of SSBs or the second plurality of SSBs is mapped to multiple ROs of the plurality of additional ROs, and at least one RO of the multiple ROs occurs after the set of additional ROs.

In some aspect, method 1400, or any aspect related to it, may be performed by an apparatus, such as communications device 1900 of FIG. 19, which includes various components operable, configured, or adapted to perform the method 1400. Communications device 1900 is described below in further detail.

Note that FIG. 14 is just one example of a method, and other methods including fewer, additional, or alternative operations are possible consistent with this disclosure.

In certain aspects, method 1400 may be performed by the apparatus to realize one or more technical effects or solutions to the aforementioned technical problem(s). For example, based on method 1400, an SSB-RO mapping for additional ROs may define how SSBs are mapped to the additional ROs to enable the apparatus to determine which additional RO to potentially use for a RACH procedure based on a received SSB. Subsequently, a higher quantity of ROs may be made available to the apparatus via the additional ROs to perform the RACH procedure, which may increase reliability for communications. For example, increasing the quantity of available ROs may increase a likelihood that the apparatus can successfully perform respective RACH procedures.

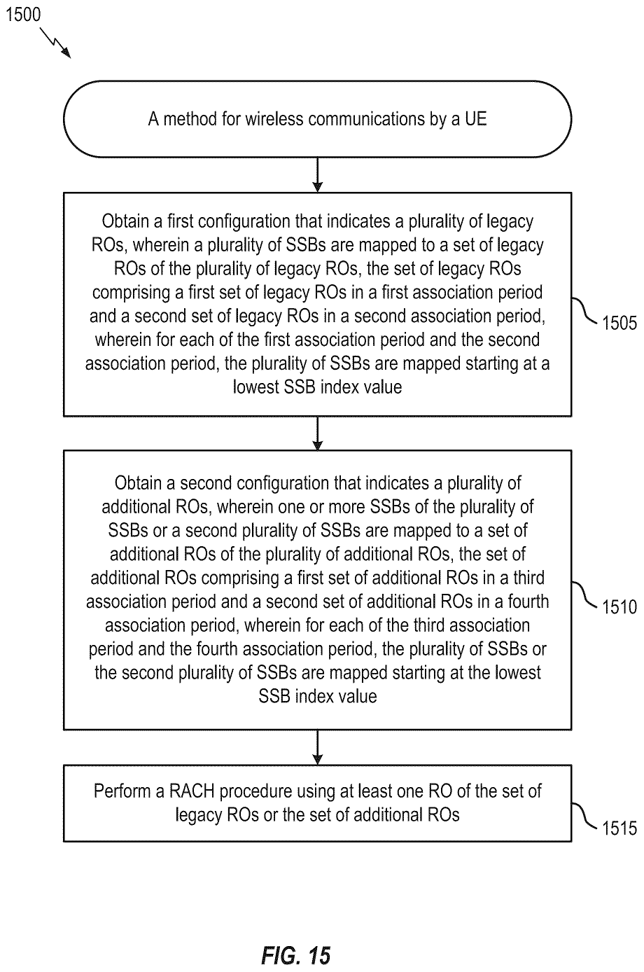

FIG. 15 shows a method 1500 for wireless communications by an apparatus, such as UE 104 of FIG. 1 or UE 304 of FIG. 3.

Method 1500 begins at block 1505 with obtaining a first configuration that indicates a plurality of legacy ROs (e.g., the first configuration 810 described with respect to FIG. 8), wherein a plurality of SSBs are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value.

Method 1500 then proceeds to block 1510 with obtaining a second configuration that indicates a plurality of additional ROs (e.g., the second configuration 812 described with respect to FIG. 8), wherein one or more SSBs of the plurality of SSBs or a second plurality of SSBs are mapped to a set of additional ROs of the plurality of additional ROs, the set of additional ROs comprising a first set of additional ROs in a third association period and a second set of additional ROs in a fourth association period, wherein for each of the third association period and the fourth association period, the plurality of SSBs or the second plurality of SSBs are mapped starting at the lowest SSB index value (e.g., as depicted and described with respect to FIGS. 11A and 11B).

Method 1500 then proceeds to block 1515 with performing a RACH procedure (e.g., the RACH procedure 814 described with respect to FIG. 8, the four-step RACH procedure 500A depicted and described with respect to FIG. 5A, and/or the two-step RACH procedure 500B depicted and described with respect to FIG. 5B) using at least one RO of the set of legacy ROs or the set of additional ROs.

In some aspects, at least one additional RO of the plurality of additional ROs occurs after the first set of additional ROs in the third association period, after the second set of additional ROs in the fourth association period, or both, and the at least one additional RO is not available for the RACH procedure.

In some aspects, at least one SSB of the plurality of SSBs or the second plurality of SSBs is mapped to multiple ROs in the third association period, in the fourth association period, or both, and at least one RO of the multiple ROs occurs after the first set of additional ROs, after the second set of additional ROs, or both.

In some aspects, a first length of the first association period or the second association period is different than a second length of the third association period or the fourth association period, a first periodicity of the first association period or the second association period is different than a second periodicity of the third association period or the fourth association period, or both.

In some aspects, method 1500 further includes obtaining an indication that the third association period and the fourth association period are to be used for mapping the one or more SSBs to the set of additional ROs.

In some aspects, method 1500 further includes obtaining the indication via at least one of: the second configuration, semi-static signaling, a system information block, or radio resource control signaling.

In some aspect, method 1500, or any aspect related to it, may be performed by an apparatus, such as communications device 1900 of FIG. 19, which includes various components operable, configured, or adapted to perform the method 1500. Communications device 1900 is described below in further detail.

Note that FIG. 15 is just one example of a method, and other methods including fewer, additional, or alternative operations are possible consistent with this disclosure.

In certain aspects, method 1500 may be performed by the apparatus to realize one or more technical effects or solutions to the aforementioned technical problem(s). For example, based on method 1500, an SSB-RO mapping for additional ROs may define how SSBs are mapped to the additional ROs to enable the apparatus to determine which additional RO to potentially use for a RACH procedure based on a received SSB. Subsequently, a higher quantity of ROs may be made available to the apparatus via the additional ROs to perform the RACH procedure, which may increase reliability for communications. For example, increasing the quantity of available ROs may increase a likelihood that the apparatus can successfully perform respective RACH procedures.

### Example Operations of a Network Entity

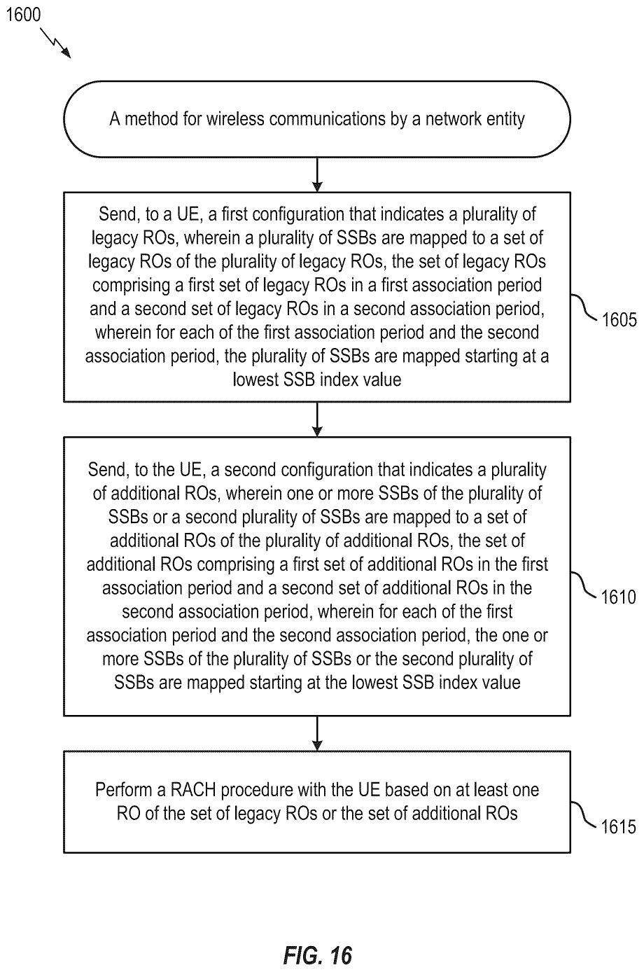

FIG. 16 shows a method 1600 for wireless communications by an apparatus, such as BS 102 of FIG. 1, a first network entity 300 or second network entity 302 of FIG. 3, or a disaggregated base station as discussed with respect to FIG. 2.

Method 1600 begins at block 1605 with sending, to a UE, a first configuration that indicates a plurality of legacy ROs (e.g., the first configuration 810 described with respect to FIG. 8), wherein a plurality of SSBs are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value.

Method 1600 then proceeds to block 1610 with sending, to the UE, a second configuration that indicates a plurality of additional ROs (e.g., the second configuration 812 described with respect to FIG. 8), wherein one or more SSBs of the plurality of SSBs or a second plurality of SSBs are mapped to a set of additional ROs of the plurality of additional ROs, the set of additional ROs comprising a first set of additional ROs in the first association period and a second set of additional ROs in the second association period, wherein for each of the first association period and the second association period, the one or more SSBs of the plurality of SSBs or the second plurality of SSBs are mapped starting at the lowest SSB index value (e.g., as depicted and described with respect to FIGS. 9A and 9B).

Method 1600 then proceeds to block 1615 with performing a RACH procedure (e.g., the RACH procedure 814 described with respect to FIG. 8, the four-step RACH procedure 500A depicted and described with respect to FIG. 5A, and/or the two-step RACH procedure 500B depicted and described with respect to FIG. 5B) with the UE based on at least one RO of the set of legacy ROs or the set of additional ROs.

In some aspects, the first association period and second association period are adjacent in time.

In some aspects, the first association period and the second association period are separated in time by at least a third association period.

In some aspects, all SSBs of the plurality of SSBs or the second plurality of SSBs are not mapped to the first set of additional ROs in the first association period, and all SSBs of the plurality of SSBs or the second plurality of SSBs are mapped collectively to the first set of additional ROs in the first association period and to a third set of additional ROs in the at least the third association period.

In some aspects, the one or more SSBs of the plurality of SSBs or the second plurality of SSBs are mapped starting at the lowest SSB index value in the second association period based at least in part on all SSBs of the plurality of SSBs or the second plurality of SSBs being mapped collectively to the first set of additional ROs in the first association period and to the third set of additional ROs in the at least the third association period.

In some aspects, at least one SSB of the plurality of SSBs or the second plurality of SSBs is mapped to multiple ROs of the first set of additional ROs and the third set of additional ROs.

In some aspects, a first subset of the plurality of SSBs or the second plurality of SSBs are mapped to the first set of additional ROs in the first association period, a second subset of the plurality of SSBs or the second plurality of SSBs are mapped to the second set of additional ROs in the second association period, all SSBs of the plurality of SSBs or the second plurality of SSBs are mapped to the first set of additional ROs in the first association period, all SSBs of the plurality of SSBs or the second plurality of SSBs are mapped to the second set of additional ROs in the second association period, or a combination thereof.

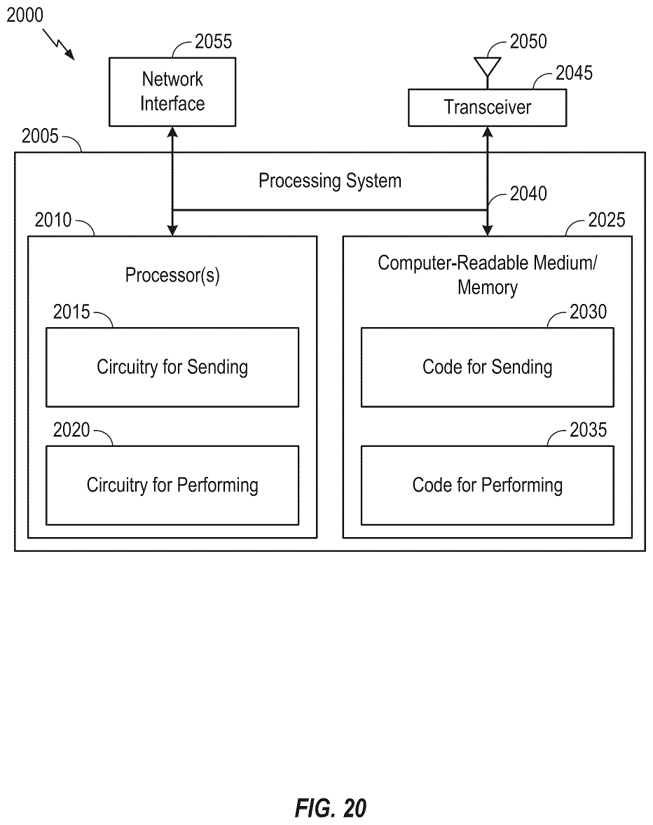

In some aspect, method 1600, or any aspect related to it, may be performed by an apparatus, such as communications device 2000 of FIG. 20, which includes various components operable, configured, or adapted to perform the method 1600. Communications device 2000 is described below in further detail.

Note that FIG. 16 is just one example of a method, and other methods including fewer, additional, or alternative operations are possible consistent with this disclosure.

In certain aspects, method 1600 may be performed by the apparatus to realize one or more technical effects or solutions to the aforementioned technical problem(s). For example, based on method 1600, the apparatus may save energy and/or reduce power consumption based on an SSB-RO mapping for additional ROs to define how SSBs are mapped to the additional ROs to enable a UE to determine which additional RO to potentially use for a RACH procedure based on a received SSB. Additionally, based on method 1600, the apparatus may save energy by dynamically adapting PRACH configurations to reduce signaling overhead (e.g., reducing and/or muting one or more of the additional ROs). Additionally or alternatively, based on method 1600, the apparatus may increase reliability for communications by dynamically adapting PRACH configurations to increase a number of available ROs (e.g., via the additional ROs), where increasing the number of ROs may increase a likelihood that UEs can successfully perform respective RACH procedures.

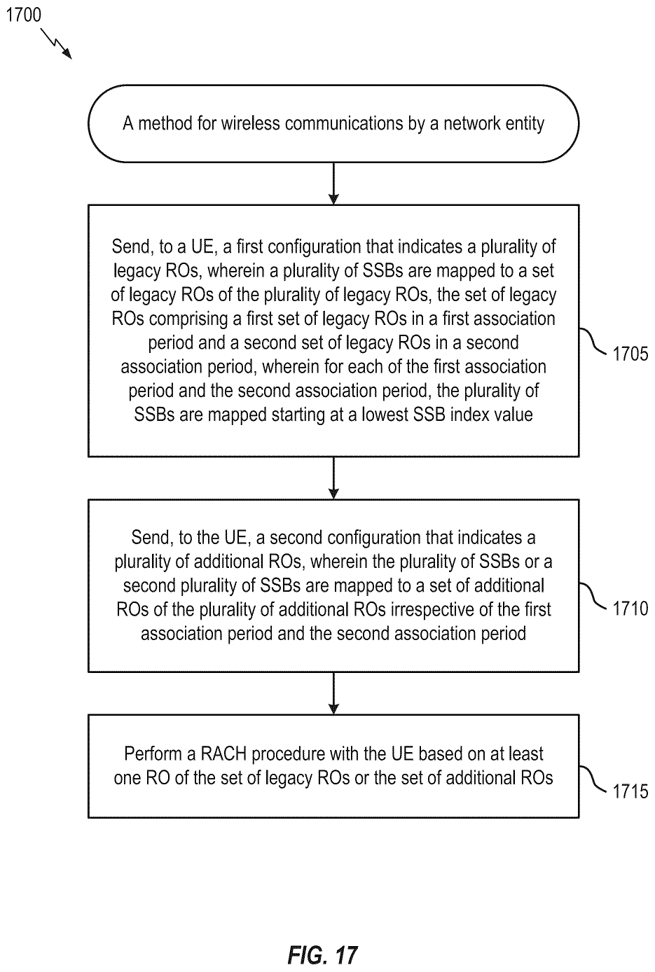

FIG. 17 shows a method 1700 for wireless communications by an apparatus, such as BS 102 of FIG. 1, a first network entity 300 or second network entity 302 of FIG. 3, or a disaggregated base station as discussed with respect to FIG. 2.

Method 1700 begins at block 1705 with sending, to a UE, a first configuration that indicates a plurality of legacy ROs (e.g., the first configuration 810 described with respect to FIG. 8), wherein a plurality of SSBs are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value.

Method 1700 then proceeds to block 1710 with sending, to the UE, a second configuration that indicates a plurality of additional ROs (e.g., the second configuration 812 described with respect to FIG. 8), wherein the plurality of SSBs or a second plurality of SSBs are mapped to a set of additional ROs of the plurality of additional ROs irrespective of the first association period and the second association period (e.g., as depicted and described with respect to FIGS. 10A and 10B).

Method 1700 then proceeds to block 1715 with performing a RACH procedure (e.g., the RACH procedure 814 described with respect to FIG. 8, the four-step RACH procedure 500A depicted and described with respect to FIG. 5A, and/or the two-step RACH procedure 500B depicted and described with respect to FIG. 5B) with the UE based on at least one RO of the set of legacy ROs or the set of additional ROs.

In some aspects, at least one additional RO of the plurality of additional ROs occurs after the set of additional ROs, and the at least one additional RO is not available for the RACH procedure.

In some aspects, at least one SSB of the plurality of SSBs or the second plurality of SSBs is mapped to multiple ROs of the plurality of additional ROs, and at least one RO of the multiple ROs occurs after the set of additional ROs.

In some aspect, method 1700, or any aspect related to it, may be performed by an apparatus, such as communications device 2000 of FIG. 20, which includes various components operable, configured, or adapted to perform the method 1700. Communications device 2000 is described below in further detail.

Note that FIG. 17 is just one example of a method, and other methods including fewer, additional, or alternative operations are possible consistent with this disclosure.

In certain aspects, method 1700 may be performed by the apparatus to realize one or more technical effects or solutions to the aforementioned technical problem(s). For example, based on method 1700, the apparatus may save energy and/or reduce power consumption based on an SSB-RO mapping for additional ROs to define how SSBs are mapped to the additional ROs to enable a UE to determine which additional RO to potentially use for a RACH procedure based on a received SSB. Additionally, based on method 1700, the apparatus may save energy by dynamically adapting PRACH configurations to reduce signaling overhead (e.g., reducing and/or muting one or more of the additional ROs). Additionally or alternatively, based on method 1700, the apparatus may increase reliability for communications by dynamically adapting PRACH configurations to increase a number of available ROs (e.g., via the additional ROs), where increasing the number of ROs may increase a likelihood that UEs can successfully perform respective RACH procedures.

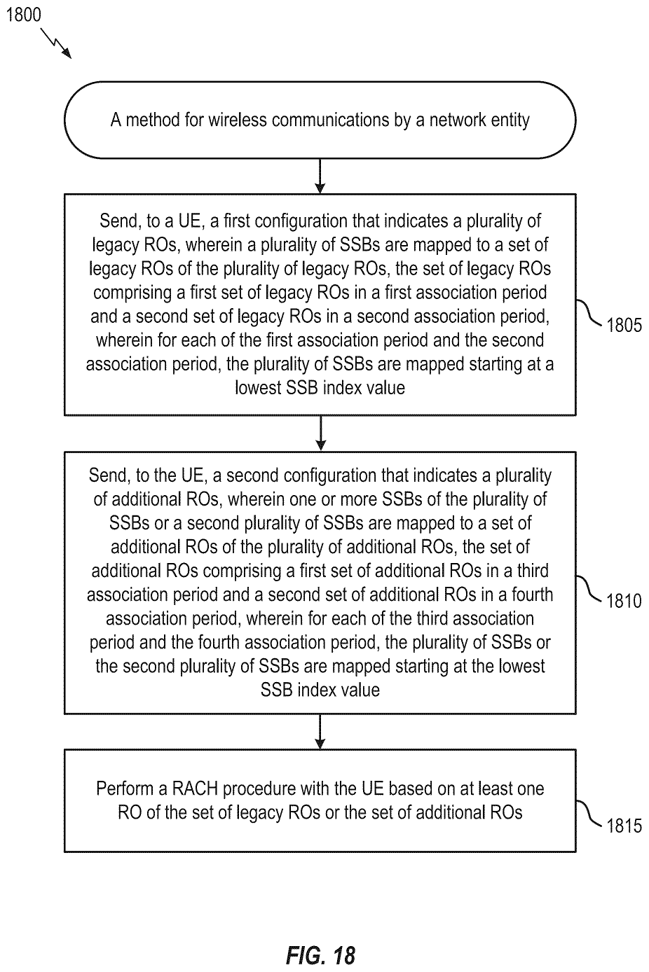

FIG. 18 shows a method 1800 for wireless communications by an apparatus, such as BS 102 of FIG. 1, a first network entity 300 or second network entity 302 of FIG. 3, or a disaggregated base station as discussed with respect to FIG. 2.

Method 1800 begins at block 1805 with sending, to a UE, a first configuration that indicates a plurality of legacy ROs (e.g., the first configuration 810 described with respect to FIG. 8), wherein a plurality of SSBs are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value.

Method 1800 then proceeds to block 1810 with sending, to the UE, a second configuration that indicates a plurality of additional ROs (e.g., the second configuration 812 described with respect to FIG. 8), wherein one or more SSBs of the plurality of SSBs or a second plurality of SSBs are mapped to a set of additional ROs of the plurality of additional ROs, the set of additional ROs comprising a first set of additional ROs in a third association period and a second set of additional ROs in a fourth association period, wherein for each of the third association period and the fourth association period, the plurality of SSBs or the second plurality of SSBs are mapped starting at the lowest SSB index value (e.g., as depicted and described with respect to FIGS. 11A and 11B).

Method 1800 then proceeds to block 1815 with performing a RACH procedure (e.g., the RACH procedure 814 described with respect to FIG. 8, the four-step RACH procedure 500A depicted and described with respect to FIG. 5A, and/or the two-step RACH procedure 500B depicted and described with respect to FIG. 5B) with the UE based on at least one RO of the set of legacy ROs or the set of additional ROs.

In some aspects, at least one additional RO of the plurality of additional ROs occurs after the first set of additional ROs in the third association period, after the second set of additional ROs in the fourth association period, or both, and the at least one additional RO is not available for the RACH procedure.

In some aspects, at least one SSB of the plurality of SSBs or the second plurality of SSBs is mapped to multiple ROs in the third association period, in the fourth association period, or both, and at least one RO of the multiple ROs occurs after the first set of additional ROs, after the second set of additional ROs, or both.

In some aspects, a first length of the first association period or the second association period is different than a second length of the third association period or the fourth association period, a first periodicity of the first association period or the second association period is different than a second periodicity of the third association period or the fourth association period, or both.

In certain aspects, method 1800 further includes sending, to the UE, an indication that the third association period and the fourth association period are to be used for mapping the one or more SSBs to the set of additional ROs.

In certain aspects, method 1800 further includes sending the indication via at least one of: the second configuration, semi-static signaling, a system information block, or radio resource control signaling.

In some aspect, method 1800, or any aspect related to it, may be performed by an apparatus, such as communications device 2000 of FIG. 20, which includes various components operable, configured, or adapted to perform the method 1800. Communications device 2000 is described below in further detail.

Note that FIG. 18 is just one example of a method, and other methods including fewer, additional, or alternative operations are possible consistent with this disclosure.

In certain aspects, method 1800 may be performed by the apparatus to realize one or more technical effects or solutions to the aforementioned technical problem(s). For example, based on method 1800, the apparatus may save energy and/or reduce power consumption based on an SSB-RO mapping for additional ROs to define how SSBs are mapped to the additional ROs to enable a UE to determine which additional RO to potentially use for a RACH procedure based on a received SSB. Additionally, based on method 1800, the apparatus may save energy by dynamically adapting PRACH configurations to reduce signaling overhead (e.g., reducing and/or muting one or more of the additional ROs). Additionally or alternatively, based on method 1800, the apparatus may increase reliability for communications by dynamically adapting PRACH configurations to increase a number of available ROs (e.g., via the additional ROs), where increasing the number of ROs may increase a likelihood that UEs can successfully perform respective RACH procedures.

### Example Communications Devices

FIG. 19 depicts aspects of an example communications device 1900 configured for wireless communications. In some aspects, communications device 1900 is a user equipment, such as UE 104 described above with respect to FIG. 1 or UE 304 described with respect to FIG. 3.

The communications device 1900 includes a processing system 1905 coupled to a transceiver 1945 (e.g., a transmitter and/or a receiver). The transceiver 1945 is configured to transmit and receive signals for the communications device 1900 via an antenna 1950, such as the various signals as described herein. The processing system 1905 may be configured to perform processing functions for the communications device 1900, including processing signals received and/or to be transmitted by the communications device 1900.

The processing system 1905 includes one or more processors 1910 and a computer-readable medium/memory 1925. In various aspects, the one or more processors 1910 may be representative of the one or more processors 318 described with respect to FIG. 3. The one or more processors 1910 are coupled to a computer-readable medium/memory 1925 via a bus 1940. In some aspects, the computer-readable medium/memory 1925 may be representative of the one or more memories 320 described with respect to FIG. 3. The computer-readable medium/memory 1925 is a non-transitory computer-readable medium/memory. In certain aspects, the computer-readable medium/memory 1925 is configured to store instructions (e.g., computer-executable code), that when executed by the one or more processors 1910, cause the one or more processors 1910 to perform the method 1300 described with respect to FIG. 13, or any aspect related to it, including any operations described in relation to FIG. 13; the method 1400 described with respect to FIG. 14, or any aspect related to it, including any operations described in relation to FIG. 14; and the method 1500 described with respect to FIG. 15, or any aspect related to it, including any operations described in relation to FIG. 15. Note that reference to a processor performing a function of communications device 1900 may include one or more processors performing that function of communications device 1900, such as in a distributed fashion.

In the depicted example, computer-readable medium/memory 1925 stores code (e.g., executable instructions), including code for obtaining 1930 and code for performing 1935. Processing of the code 1930 and 1935 may enable and cause the communications device 1900 to perform the method 1300 described with respect to FIG. 13, or any aspect related to it; the method 1400 described with respect to FIG. 14, or any aspect related to it; and the method 1500 described with respect to FIG. 15, or any aspect related to it.

The one or more processors 1910 include circuitry configured to implement (e.g., execute) the code stored in the computer-readable medium/memory 1925, including circuitry for obtaining 1915 and circuitry for performing 1920. Processing with circuitry 1915 and 1920 may enable and cause the communications device 1900 to perform the method 1300 described with respect to FIG. 13, or any aspect related to it; the method 1400 described with respect to FIG. 14, or any aspect related to it; and the method 1500 described with respect to FIG. 15, or any aspect related to it.

More generally, means for communicating, performing, transmitting, sending or outputting for transmission may include the one or more transceivers 324, one or more antenna 322 and/or processing system 316 of the UE 304 illustrated in FIG. 3, transceiver 1945 and/or antenna 1950 of the communications device 1900 in FIG. 19, and/or one or more processors 1910 of the communications device 1900 in FIG. 19. Means for communicating, receiving, obtaining, or performing may include the one or more transceivers 324, one or more antennas 322, and/or processing system 316 of the UE 304 illustrated in FIG. 3, transceiver 1945 and/or antenna 1950 of the communications device 1900 in FIG. 19, and/or one or more processors 1910 of the communications device 1900 in FIG. 19.

FIG. 20 depicts aspects of an example communications device configured for wireless communications. In some aspects, communications device 2000 is a network entity, such as BS 102 of FIG. 1, first network entity 300 or second network entity 302 of FIG. 3, or a disaggregated base station as discussed with respect to FIG. 2.

The communications device 2000 includes a processing system 2005 coupled to a transceiver 2045 (e.g., a transmitter and/or a receiver) and/or a network interface 2055. The transceiver 2045 is configured to transmit and receive signals for the communications device 2000 via an antenna 2050, such as the various signals as described herein. The network interface 2055 is configured to obtain and send signals for the communications device 2000 via communications link(s), such as a backhaul link, midhaul link, and/or fronthaul link as described herein, such as with respect to FIG. 2. The processing system 2005 may be configured to perform processing functions for the communications device 2000, including processing signals received and/or to be transmitted by the communications device 2000.

The processing system 2005 includes one or more processors 2010 and a computer-readable medium/memory 2025. In various aspects, one or more processors 2010 may be representative of the one or more processors 308, as described with respect to FIG. 3. The one or more processors 2010 are coupled to the computer-readable medium/memory 2025 via a bus 2040. In certain aspects, the computer-readable medium/memory 2025 is configured to store instructions (e.g., computer-executable code), including code 2030 and 2035, that when executed by the one or more processors 2010, cause the one or more processors 2010 to perform the method 1600 described with respect to FIG. 16, or any aspect related to it, including any operations described in relation to FIG. 16; the method 1700 described with respect to FIG. 17, or any aspect related to it, including any operations described in relation to FIG. 17; and the method 1800 described with respect to FIG. 18, or any aspect related to it, including any operations described in relation to FIG. 18. The computer-readable medium/memory 2025 is a non-transitory computer-readable medium/memory. Note that reference to a processor of communications device 2000 performing a function may include one or more processors of communications device 2000 performing that function, such as in a distributed fashion.

In the depicted example, the computer-readable medium/memory 2025 stores code (e.g., executable instructions), including code for sending 2030 and code for performing 2035. Processing of the code 2030 and 2035 may enable and cause the communications device 2000 to perform the method 1600 described with respect to FIG. 16, or any aspect related to it; the method 1700 described with respect to FIG. 17, or any aspect related to it; and the method 1800 described with respect to FIG. 18, or any aspect related to it.

The one or more processors 2010 include circuitry configured to implement (e.g., execute) the code stored in the computer-readable medium/memory 2025, including circuitry for sending 2015 and circuitry for performing 2020. Processing with circuitry 2015 and 2020 may enable and cause the communications device 2000 to perform the method 1600 described with respect to FIG. 16, or any aspect related to it; the method 1700 described with respect to FIG. 17, or any aspect related to it; and the method 1800 described with respect to FIG. 18, or any aspect related to it.

Various components of the communications device 2000 may provide means for performing the method 1600 described with respect to FIG. 16, or any aspect related to it; the method 1700 described with respect to FIG. 17, or any aspect related to it; and the method 1800 described with respect to FIG. 18, or any aspect related to it. Means for communicating, performing, transmitting, sending or outputting for transmission may include the one or more transceivers 312, one or more antennas 314, and/or processing system 306 of the first network entity 300 or the second network entity 302 illustrated in FIG. 3, transceiver 2045, antenna 2050, and/or network interface 2055 of the communications device 2000 in FIG. 20, and/or one or more processors 2010 of the communications device 2000 in FIG. 20. Means for communicating, receiving, obtaining, or performing may include the one or more transceivers 312, one or more antennas 314, and/or processing system 306 of the first network entity 300 or the second network entity 302 illustrated in FIG. 3, transceiver 2045, antenna 2050, and/or network interface 2055 of the communications device 2000 in FIG. 20, and/or one or more processors 2010 of the communications device 2000 in FIG. 20. For example, means for performing of the method 1600 described with respect to FIG. 16, or any aspect related to it; the method 1700 described with respect to FIG. 17, or any aspect related to it; and the method 1800 described with respect to FIG. 18, or any aspect related to it, may include means for performing.

### Example Clauses

Implementation examples are described in the following numbered clauses:

Clause 1: A method for wireless communications by a UE comprising: obtaining a first configuration that indicates a plurality of legacy ROs, wherein a plurality of SSBs are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value; obtaining a second configuration that indicates a plurality of additional ROs, wherein one or more SSBs of the plurality of SSBs or a second plurality of SSBs are mapped to a set of additional ROs of the plurality of additional ROs, the set of additional ROs comprising a first set of additional ROs in the first association period and a second set of additional ROs in the second association period, wherein for each of the first association period and the second association period, the one or more SSBs of the plurality of SSBs or the second plurality of SSBs are mapped starting at the lowest SSB index value; and performing a RACH procedure using at least one RO of the set of legacy ROs or the set of additional ROs.

Clause 2: The method of Clause 1, wherein the first association period and second association period are adjacent in time.

Clause 3: The method of any one of Clauses 1-2, wherein the first association period and the second association period are separated in time by at least a third association period.

Clause 4: The method of Clause 3, wherein: all SSBs of the plurality of SSBs or the second plurality of SSBs are not mapped to the first set of additional ROs in the first association period, and all SSBs of the plurality of SSBs or the second plurality of SSBs are mapped collectively to the first set of additional ROs in the first association period and to a third set of additional ROs in the at least the third association period.

Clause 5: The method of Clause 4, wherein the one or more SSBs of the plurality of SSBs or the second plurality of SSBs are mapped starting at the lowest SSB index value in the second association period based at least in part on all SSBs of the plurality of SSBs or the second plurality of SSBs being mapped collectively to the first set of additional ROs in the first association period and to the third set of additional ROs in the at least the third association period.

Clause 6: The method of Clause 4, wherein at least one SSB of the plurality of SSBs or the second plurality of SSBs is mapped to multiple ROs of the first set of additional ROs and the third set of additional ROs.

Clause 7: The method of any one of Clauses 1-6, wherein: a first subset of the plurality of SSBs or the second plurality of SSBs are mapped to the first set of additional ROs in the first association period, a second subset of the plurality of SSBs or the second plurality of SSBs are mapped to the second set of additional ROs in the second association period, all SSBs of the plurality of SSBs or the second plurality of SSBs are mapped to the first set of additional ROs in the first association period, all SSBs of the plurality of SSBs or the second plurality of SSBs are mapped to the second set of additional ROs in the second association period, or a combination thereof.

Clause 8: A method for wireless communications by a UE comprising: obtaining a first configuration that indicates a plurality of legacy ROs, wherein a plurality of SSBs are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value; obtaining a second configuration that indicates a plurality of additional ROs, wherein the plurality of SSBs or a second plurality of SSBs are mapped to a set of additional ROs of the plurality of additional ROs irrespective of the first association period and the second association period; and performing a RACH procedure using at least one RO of the set of legacy ROs or the set of additional ROs.

Clause 9: The method of Clause 8, wherein: at least one additional RO of the plurality of additional ROs occurs after the set of additional ROs, and the at least one additional RO is not available for the RACH procedure.

Clause 10: The method of any one of Clauses 8-9, wherein: at least one SSB of the plurality of SSBs or the second plurality of SSBs is mapped to multiple ROs of the plurality of additional ROs, and at least one RO of the multiple ROs occurs after the set of additional ROs.

Clause 11: A method for wireless communications by a UE comprising: obtaining a first configuration that indicates a plurality of legacy ROs, wherein a plurality of SSBs are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value; obtaining a second configuration that indicates a plurality of additional ROs, wherein one or more SSBs of the plurality of SSBs or a second plurality of SSBs are mapped to a set of additional ROs of the plurality of additional ROs, the set of additional ROs comprising a first set of additional ROs in a third association period and a second set of additional ROs in a fourth association period, wherein for each of the third association period and the fourth association period, the plurality of SSBs or the second plurality of SSBs are mapped starting at the lowest SSB index value; and performing a RACH procedure using at least one RO of the set of legacy ROs or the set of additional ROs.

Clause 12: The method of Clause 11, wherein: at least one additional RO of the plurality of additional ROs occurs after the first set of additional ROs in the third association period, after the second set of additional ROs in the fourth association period, or both, and the at least one additional RO is not available for the RACH procedure.

Clause 13: The method of any one of Clauses 11-12, wherein: at least one SSB of the plurality of SSBs or the second plurality of SSBs is mapped to multiple ROs in the third association period, in the fourth association period, or both, and at least one RO of the multiple ROs occurs after the first set of additional ROs, after the second set of additional ROs, or both.

Clause 14: The method of any one of Clauses 11-13, wherein: a first length of the first association period or the second association period is different than a second length of the third association period or the fourth association period, a first periodicity of the first association period or the second association period is different than a second periodicity of the third association period or the fourth association period, or both.

Clause 15: The method of any one of Clauses 11-14, further comprising obtaining an indication that the third association period and the fourth association period are to be used for mapping the one or more SSBs to the set of additional ROs.

Clause 16: The method of Clause 15, further comprising obtaining the indication via at least one of: the second configuration, semi-static signaling, a system information block, or radio resource control signaling.

Clause 17: A method for wireless communications by a network entity comprising: sending, to a UE, a first configuration that indicates a plurality of legacy ROs, wherein a plurality of SSBs are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value; sending, to the UE, a second configuration that indicates a plurality of additional ROs, wherein one or more SSBs of the plurality of SSBs or a second plurality of SSBs are mapped to a set of additional ROs of the plurality of additional ROs, the set of additional ROs comprising a first set of additional ROs in the first association period and a second set of additional ROs in the second association period, wherein for each of the first association period and the second association period, the one or more SSBs of the plurality of SSBs or the second plurality of SSBs are mapped starting at the lowest SSB index value; and performing a RACH procedure with the UE based on at least one RO of the set of legacy ROs or the set of additional ROs.

Clause 18: The method of Clause 17, wherein the first association period and second association period are adjacent in time.

Clause 19: The method of any one of Clauses 17-18, wherein the first association period and the second association period are separated in time by at least a third association period.

Clause 20: The method of Clause 19, wherein: all SSBs of the plurality of SSBs or the second plurality of SSBs are not mapped to the first set of additional ROs in the first association period, and all SSBs of the plurality of SSBs or the second plurality of SSBs are mapped collectively to the first set of additional ROs in the first association period and to a third set of additional ROs in the at least the third association period.

Clause 21: The method of Clause 20, wherein the one or more SSBs of the plurality of SSBs or the second plurality of SSBs are mapped starting at the lowest SSB index value in the second association period based at least in part on all SSBs of the plurality of SSBs or the second plurality of SSBs being mapped collectively to the first set of additional ROs in the first association period and to the third set of additional ROs in the at least the third association period.

Clause 22: The method of Clause 20, wherein at least one SSB of the plurality of SSBs or the second plurality of SSBs is mapped to multiple ROs of the first set of additional ROs and the third set of additional ROs.

Clause 23: The method of any one of Clauses 17-22, wherein: a first subset of the plurality of SSBs or the second plurality of SSBs are mapped to the first set of additional ROs in the first association period, a second subset of the plurality of SSBs or the second plurality of SSBs are mapped to the second set of additional ROs in the second association period, all SSBs of the plurality of SSBs or the second plurality of SSBs are mapped to the first set of additional ROs in the first association period, all SSBs of the plurality of SSBs or the second plurality of SSBs are mapped to the second set of additional ROs in the second association period, or a combination thereof.

Clause 24: A method for wireless communications by a network entity comprising: sending, to a UE, a first configuration that indicates a plurality of legacy ROs, wherein a plurality of SSBs are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value; sending, to the UE, a second configuration that indicates a plurality of additional ROs, wherein the plurality of SSBs or a second plurality of SSBs are mapped to a set of additional ROs of the plurality of additional ROs irrespective of the first association period and the second association period; and performing a RACH procedure with the UE based on at least one RO of the set of legacy ROs or the set of additional ROs.

Clause 25: The method of Clause 24, wherein: at least one additional RO of the plurality of additional ROs occurs after the set of additional ROs, and the at least one additional RO is not available for the RACH procedure.

Clause 26: The method of any one of Clauses 24-25, wherein: at least one SSB of the plurality of SSBs or the second plurality of SSBs is mapped to multiple ROs of the plurality of additional ROs, and at least one RO of the multiple ROs occurs after the set of additional ROs.

Clause 27: A method for wireless communications by a network entity comprising: sending, to a UE, a first configuration that indicates a plurality of legacy ROs, wherein a plurality of SSBs are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value; sending, to the UE, a second configuration that indicates a plurality of additional ROs, wherein one or more SSBs of the plurality of SSBs or a second plurality of SSBs are mapped to a set of additional ROs of the plurality of additional ROs, the set of additional ROs comprising a first set of additional ROs in a third association period and a second set of additional ROs in a fourth association period, wherein for each of the third association period and the fourth association period, the plurality of SSBs or the second plurality of SSBs are mapped starting at the lowest SSB index value; and performing a RACH procedure with the UE based on at least one RO of the set of legacy ROs or the set of additional ROs.

Clause 28: The method of Clause 27, wherein: at least one additional RO of the plurality of additional ROs occurs after the first set of additional ROs in the third association period, after the second set of additional ROs in the fourth association period, or both, and the at least one additional RO is not available for the RACH procedure.

Clause 29: The method of any one of Clauses 27-28, wherein: at least one SSB of the plurality of SSBs or the second plurality of SSBs is mapped to multiple ROs in the third association period, in the fourth association period, or both, and at least one RO of the multiple ROs occurs after the first set of additional ROs, after the second set of additional ROs, or both.

Clause 30: The method of any one of Clauses 27-29, wherein: a first length of the first association period or the second association period is different than a second length of the third association period or the fourth association period, a first periodicity of the first association period or the second association period is different than a second periodicity of the third association period or the fourth association period, or both.

Clause 31: The method of any one of Clauses 27-30, further comprising sending, to the UE, an indication that the third association period and the fourth association period are to be used for mapping the one or more SSBs to the set of additional ROs.

Clause 32: The method of Clause 31, further comprising sending the indication via at least one of: the second configuration, semi-static signaling, a system information block, or radio resource control signaling.

Clause 33: One or more apparatuses, comprising: one or more memories comprising executable instructions; and one or more processors configured to execute the executable instructions and cause the one or more apparatuses to perform a method in accordance with any one of Clauses 1-32.

Clause 34: One or more apparatuses configured for wireless communications, comprising: one or more memories; and one or more processors, coupled to the one or more memories, configured to cause the one or more apparatuses to perform a method in accordance with any one of Clauses 1-32.

Clause 35: One or more apparatuses configured for wireless communications, comprising: one or more memories; and one or more processors, coupled to the one or more memories, configured to perform a method in accordance with any one of Clauses 1-32.

Clause 36: One or more apparatuses, comprising means for performing a method in accordance with any one of Clauses 1-32.

Clause 37: One or more non-transitory computer-readable media comprising executable instructions that, when executed by one or more processors of one or more apparatuses, cause the one or more apparatuses to perform a method in accordance with any one of Clauses 1-32.

Clause 38: One or more computer program products embodied on one or more computer-readable storage media comprising code for performing a method in accordance with any one of Clauses 1-32.

Clause 39: One or more apparatuses configured for wireless communications, comprising: a processing system that includes one or more processors and one or more memories coupled with the one or more processors, the processing system configured to cause the one or more apparatuses to perform a method in accordance with any one of Clauses 1-32.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising a processing system, the processing system comprising one or more memories and one or more processors coupled to the one or more memories, the processing system configured to cause a user equipment (UE) to:
obtain a first configuration that indicates a plurality of legacy random access occasions (ROs), wherein a plurality of synchronization signal blocks (SSBs) are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value;
obtain a second configuration that indicates a plurality of additional ROs, wherein one or more SSBs of the plurality of SSBs or a second plurality of SSBs are mapped to a set of additional ROs of the plurality of additional ROs, the set of additional ROs comprising a first set of additional ROs in the first association period and a second set of additional ROs in the second association period, wherein for each of the first association period and the second association period, the one or more SSBs of the plurality of SSBs or the second plurality of SSBs are mapped starting at the lowest SSB index value; and
perform a random access channel (RACH) procedure using at least one RO of the set of legacy ROs or the set of additional ROs.

2. The apparatus of claim 1, wherein the first association period and second association period are adjacent in time.

3. The apparatus of claim 1, wherein the first association period and the second association period are separated in time by at least a third association period.

4. The apparatus of claim 3, wherein:
all SSBs of the plurality of SSBs or the second plurality of SSBs are not mapped to the first set of additional ROs in the first association period, and
all SSBs of the plurality of SSBs or the second plurality of SSBs are mapped collectively to the first set of additional ROs in the first association period and to a third set of additional ROs in the at least the third association period.

5. The apparatus of claim 4, wherein the one or more SSBs of the plurality of SSBs or the second plurality of SSBs are mapped starting at the lowest SSB index value in the second association period based at least in part on all SSBs of the plurality of SSBs or the second plurality of SSBs being mapped collectively to the first set of additional ROs in the first association period and to the third set of additional ROs in the at least the third association period.

6. The apparatus of claim 4, wherein at least one SSB of the plurality of SSBs or the second plurality of SSBs is mapped to multiple ROs of the first set of additional ROs and the third set of additional ROs.

7. The apparatus of claim 1, wherein:
a first subset of the plurality of SSBs or the second plurality of SSBs are mapped to the first set of additional ROs in the first association period,
a second subset of the plurality of SSBs or the second plurality of SSBs are mapped to the second set of additional ROs in the second association period,
all SSBs of the plurality of SSBs or the second plurality of SSBs are mapped to the first set of additional ROs in the first association period,
all SSBs of the plurality of SSBs or the second plurality of SSBs are mapped to the second set of additional ROs in the second association period, or
a combination thereof.

8. An apparatus comprising a processing system, the processing system comprising one or more memories and one or more processors coupled to the one or more memories, the processing system configured to cause a user equipment (UE) to:
obtain a first configuration that indicates a plurality of legacy random access occasions (ROs), wherein a plurality of synchronization signal blocks (SSBs) are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value;
obtain a second configuration that indicates a plurality of additional ROs, wherein the plurality of SSBs or a second plurality of SSBs are mapped to a set of additional ROs of the plurality of additional ROs irrespective of the first association period and the second association period; and
perform a random access channel (RACH) procedure using at least one RO of the set of legacy ROs or the set of additional ROs.

9. The apparatus of claim 8, wherein:
at least one additional RO of the plurality of additional ROs occurs after the set of additional ROs, and
the at least one additional RO is not available for the RACH procedure.

10. The apparatus of claim 8, wherein:
at least one SSB of the plurality of SSBs or the second plurality of SSBs is mapped to multiple ROs of the plurality of additional ROs, and
at least one RO of the multiple ROs occurs after the set of additional ROs.

11. An apparatus comprising a processing system, the processing system comprising one or more memories and one or more processors coupled to the one or more memories, the processing system configured to cause a user equipment (UE) to:
obtain a first configuration that indicates a plurality of legacy random access occasions (ROs), wherein a plurality of synchronization signal blocks (SSBs) are mapped to a set of legacy ROs of the plurality of legacy ROs, the set of legacy ROs comprising a first set of legacy ROs in a first association period and a second set of legacy ROs in a second association period, wherein for each of the first association period and the second association period, the plurality of SSBs are mapped starting at a lowest SSB index value;
obtain a second configuration that indicates a plurality of additional ROs, wherein one or more SSBs of the plurality of SSBs or a second plurality of SSBs are mapped to a set of additional ROs of the plurality of additional ROs, the set of additional ROs comprising a first set of additional ROs in a third association period and a second set of additional ROs in a fourth association period, wherein for each of the third association period and the fourth association period, the plurality of SSBs or the second plurality of SSBs are mapped starting at the lowest SSB index value; and
perform a random access channel (RACH) procedure using at least one RO of the set of legacy ROs or the set of additional ROs.

12. The apparatus of claim 11, wherein:
at least one additional RO of the plurality of additional ROs occurs after the first set of additional ROs in the third association period, after the second set of additional ROs in the fourth association period, or both, and
the at least one additional RO is not available for the RACH procedure.

13. The apparatus of claim 11, wherein:
at least one SSB of the plurality of SSBs or the second plurality of SSBs is mapped to multiple ROs in the third association period, in the fourth association period, or both, and
at least one RO of the multiple ROs occurs after the first set of additional ROs, after the second set of additional ROs, or both.

14. The apparatus of claim 11, wherein:
a first length of the first association period or the second association period is different than a second length of the third association period or the fourth association period,
a first periodicity of the first association period or the second association period is different than a second periodicity of the third association period or the fourth association period, or
both.

15. The apparatus of claim 11, wherein the processing system is configured to cause the UE to obtain an indication that the third association period and the fourth association period are to be used for mapping the one or more SSBs to the set of additional ROs.

16. The apparatus of claim 15, wherein the processing system is configured to cause the UE to obtain the indication via at least one of: the second configuration, semi-static signaling, a system information block, or radio resource control signaling.
